(19) United States
(12) Patent Application Publication
(10) Pub. No.: US 2003/0068559 A1
(43) Pub. Date: Apr. 10, 2003

(54) Apparatus and method for the design and manufacture of multifunctional composite materials with power integration

(76) Inventors: Joseph H. Armstrong, Littleton, CO (US); Bruce Lanning, Littleton, CO (US); Martin H. Benson, Littleton, CO (US); Bernd J. Neudecker, Littleton, CO (US)

Correspondence Address: MCKENNA LONG & ALDRIDGE LLP, 1900 K STREET NW, WASHINGTON, DC, 20006, US

(21) Appl. No.: 10/238,612

(22) Filed: Sep. 11, 2002

Related U.S. Application Data
(60) Provisional application No. 60/318,319, filed on Sep. 12, 2001.

(51) Int. Cl. H01M 4/66; B05D 5/00; D02G 3/00

(52) U.S. Cl. 429/234; 428/375; 427/256

(57) ABSTRACT

The manufacture and use of multilayer functional thin-film devices, such as solid-state thin-film batteries, including lithium thin-film batteries on unconventional substrate geometries integrated into multifunctional materials is described. The unconventional geometries may include fibers, ribbons, and strips, which may be woven together or held together in matrices of material to form structural or other multifunctional composites with, for example, integrated power.

### CROSS REFERENCE TO RELATED APPLICATIONS

The present application is related to and claims the benefit of, under 35 U.S.C. § 119(e), U.S. Provisional Patent Application Serial No. 60/318,319, filed Sep. 12, 2001, which is expressly incorporated fully herein by reference.

### GOVERNMENT INTEREST

This invention may have been made with Government support under Contract Number N00014-00-C-0479 awarded by Office of Naval Research. The Government may have certain rights in this invention.

### FIELD OF THE INVENTION

The present invention relates to the manufacture and use of multilayer functional thin-film devices, such as solid-state thin-film batteries, including lithium thin-film batteries on unconventional substrate geometries integrated into multifunctional materials. The unconventional geometries may include fibers, ribbons, and strips, which may be woven together or held together in matrices of material to form structural or other multifunctional composites with, for example, integrated power.

### BACKGROUND OF THE INVENTION

1. Description of the Art

Because the present invention relates to creating multilayer materials by means of shadow masking a vacuum coating process on a fibrous substrate, the technology relates to two general categories: shadow masking of multilayer and multifunctional thin-film coatings and vacuum coating of fibrous monofilament substrates.

A technique widely used in the vacuum thin-film industry to selectively deposit sequential or multilayer thin films in specific patterns is the application of a physical constraint to the vapor or plasma to prevent the vapor or plasma from reaching areas not targeted for deposition. The types of masks generally used include fabricated metal, glass, and ceramics, as well as photoresist-patterned masking. The primary applications of these technologies have traditionally been restricted to planar substrate geometries. Examples of thin-film product areas utilizing physical shadow masks include thin-film batteries, electronic integrated microcircuits, circuit boards, diode arrays, electroluminescent devices, and semiconductor devices. Examples of these products may be found in, for example, U.S. Pat. Nos. 4,952,420; 6,214,631; 4,915,057; international patent application WO 9930336; and German patent DE 19850424.

Additionally, the production of patterned multilayer thin films by sequential shadow masking has been explored. For example, in thin-film battery designs, metal templates or shadow masks have been used to control the deposition of battery films in specific geometries to perform specific functions. Some of these functions include cathode-to-anode pairing, electrolyte separation, and current collector masking. Examples of planar configuration shadow masking are disclosed, for example, in U.S. Pat. Nos. 6,218,049; 5,567,210; 5,338,625; 6,168,884; 5,445,906; 6,066,361; and international patent application WO 9847196. Additionally, some examples of shadow masking on fiber substrates include European patent application EP 1030197 and U.S. Pat. No. 5,308,656.

Photoresist masking for patterning vacuum deposited thin films is disclosed, for example, in U.S. Pat. Nos. 6,093,973; 6,063,547; 5,641,612; 6,066,361; and 5,273,622; and also in British patent application GB 2320135 and European patent application EP 1100120.

Vacuum thin-film coatings have been used in, for example, fiber-reinforced composite materials, superconducting fibers and wires, as well as optical fiber applications. Research in vacuum-coated fibers has primarily been confined to continuous substrate deposition. Some examples of continuous fiber coating apparatuses are found in U.S. Pat. Nos. 5,518,597; 5,178,743; 4,530,750; 5,273,622; 4,863,576; 5,426,000; 5,228,963; international patent application WO 0056949 and European patent application EP 0455408; and Russian patent RU 2121464. Some examples of composite material fiber coating include U.S. Pat. Nos. 5,426,000; 5,378,500; 5,354,615; and European patent EP 0423946 and British patent GB 2279667. Some examples of optical fiber coating include U.S. Pat. Nos. 5,717,808; 4,726,319; 5,320,659; 5,346,520; and European patent EP 0419882. Some examples of superconducting wire and fiber coatings include U.S. Pat. Nos. 6,154,599; 5,140,004; 5,079,218; and European patent application EP 290127. Some examples of structural composites utilizing deposited reinforced fibers include U.S. Pat. Nos. 5,454,403 and 6,245,425 and European patent applications EP 0938592 and EP 0299483.

Publications also show glass fiber containing battery separators and carbon fibers being used as anode materials and fibrous cathodes in batteries such as, for example, U.S. Pat. Nos. 6,004,691 and 5,916,514, although the scope, chemistry, fabrication method, and dimensions are different. Additional literature relating to full batteries fabricated on fiber composites and certain support composite material is disclosed in European patent applications EP 0806805 and EP 1014387, and European patent EP 0806806; however, these specifications disclose bulk batteries, as opposed to thin-film batteries.

Solid-state lithium-based thin-film batteries are also available; however, they have not been incorporated into use for fibrous, strip, and ribbon like substrates, nor with subsequent integration into composite matrices.

### SUMMARY OF THE INVENTION

This invention responds to the problems described above by teaching novel synthetic multifunctional materials, with functional integration and methods for making such materials. Preferred functions that may be integrated with the present invention include, for example, power storage and production. These multifunctional materials may be produced in a wide array of structural forms, such as rods, bars, tubes, monotapes, ribbons, weaves, or ropes. The multifunctional materials may comprise, for example, a fibrous or ribbon-like structural substrate coated with a multilayer functionally patterned thin-film. In addition to performing their function, the patterned thin films may also provide structure within the composite. The combination of a substrate and one or more thin-film layers may be described herein as a laden substrate.

One embodiment of the present invention relates to the fabrication of integrated structural composite materials. This fabrication process may involve selecting one or more substrates, applying functional thin-films to one or more of these substrates to create at least one laden substrate, and creating a layup of one or more of these laden substrates into a structural composite array. Further steps may include selecting and applying configuring material and consolidating the composite.

The substrate may be selected to have a complimentary or unrelated function with respect to the thin-film functional pattern. For example, the substrate may conduct electricity, which may be useful in certain battery or photovoltaic cell applications. Moreover, the substrate may be purely structural, possessing qualities that may only indirectly relate to the function of the device, such as rigidity, tensile strength, or ability to form a particular shape. Additionally, the substrate may perform an unrelated function, or an only indirectly related function, such as, for example, providing a communication signal (e.g., an optical fiber) or providing ballistic protection (e.g., a puncture resistant fiber such as, a Kevlar® or Aramid® fiber). When used with an optical fiber substrate, the deposited device may, for example, comprise a battery, which may be used to boost the optical signal as needed. Thus, although there is a relationship between the function of the thin-film layers and the function of the optical fiber, the relationship is indirect. When used with a puncture resistant fiber, the deposited device may, for example, comprise a battery or solar power cell and may be used as a supplemental power source for someone wearing ballistic garments or for an exoskeleton power structure for robotic or airborne operations. Nevertheless, although the combination of fiber and thin-film functional patterns may provide multiple functions, the functions need not be related to one another.

The shapes of the substrate that may be used in the present invention may include, for example, substrates that are cylindrical or conical, monofilaments, fibers or fibrous substrates, wires, rods, ribbons or ribbon-like substrates, strips or strip-like substrates, or any other equivalently shaped substrates. The substrates may include such materials as, for example, glass, ceramic, polymer, optical fiber, metal, alloy, carbon, semi-conductor, super-conductor, shape memory alloy, or polished natural fibers. Natural fibers may include such fibers as those found, for example, in wool, cotton, hemp, and wood. These materials and shapes are exemplary only and not limiting. Combinations of those materials and shapes with one another and with other materials and shapes not described are also permitted. Other materials and shapes will be apparent to one skilled in the art, including tubular and irregular shapes. Structural properties of the resultant composite materials may be modified by the choice of substrate. Polymer and metal substrates, for example, may provide a ductile component in monotape, ribbon, and woven fabric and rope applications. Rigid substrates such as carbides and other ceramics, for example, provide high strength reinforcement for solids in other structural applications.

For fibrous substrates, a preferred diameter of the substrate is between about one micron and about one-quarter inch. For substrates having rectangular shape, the length of each of the sides (height or width of the substrate) is preferably between about one micron and about five inches.

The length of the laden substrate may be between about one-quarter inch and three hundred meters. In a multifunctional material, the substrate may provide between about five and about ninety percent of the volume of the multifunctional material. Similarly, the thin-film functional pattern or patterns may provide between about 0.1 and about 90 percent of the volume of the multifunctional material.

The patterned films deposited on a substrate used in this invention may include thin-film electrochemical devices such as solid-state batteries or photovoltaic cells, thin-film micro-electronic multiple interconnect devices, or other functional patterns on fibrous or ribbon-like substrates.

One embodiment of the present invention may be a functional pattern, such as a thin-film battery applied by a deposition process while using a shadow mask. The shape of each layer of the pattern may, in this instance, be controlled by means of a shadow mask. The shadow mask may, for example, be a sleeve or hollow tube through which the substrate may be threaded. A preferred method for shadow masking is accomplished by means of a tubular member in which the substrate is preferably non-contactively disposed, for example, threaded in such a way as that it does not touch the mask. Although shadow masks are generally two-dimensional templates in planar geometries, in the cylindrical geometry associated with a fibrous or ribbon-like substrate, it may be helpful to use a shadow mask that is a hollow cylinder.

Thin-film functional patterns, as used herein, include thin-film devices such as batteries and photovoltaic cells, and may also include micro-electric circuits. Other functional patterns will be apparent to one skilled in the art; thus the term “functional patterns” is not meant to be limited to the examples given.

Certain patterns of deposited thin films may be particularly useful in manufacturing multifunctional composite materials that include batteries on fibrous or ribbon-like substrates. These patterns may include, for example, the Li-ion solid-state battery configuration, the buried Li-ion solid-state battery configuration, the Li-free solid-state battery configuration, the buried Li-free solid-state battery configuration, the lithium solid-state battery configuration, and the buried lithium solid-state battery configuration . Other patterns may include, for example, a photovoltaic device configuration and a multilayer electronic interconnect layer.

The layup of the substrates refers to the physical organization or arrangement of the laden substrates. In an embodiment that includes a plurality of substrates, the substrates may be intertwined. For example, intertwining may include weaving or braiding the substrates, intertwining the substrate with itself, or intertwining the substrate with a non-substrate material. Other examples of layups may include laying several laden substrates parallel to one another or placing substrates into a mold.

An additional material added to the substrate will be referred to as the configuring material, although, as described above, the configuration of the resultant composite material may be determined by the substrate. Moreoever, a second substrate, or a second portion of a first substrate, may in some instances serve as the configuring material.

The configuring material may posses certain beneficial properties. For example, a configuring material may reinforce the laden substrate or the multifunctional material, be reinforced by the laden substrate or the multifunctional material, insulate (thermally and/or electrically) the laden substrate or the multifunctional material, provide heat transfer to and/or from the laden substrate or the multifunctional material, shade the laden substrate or the multifunctional material, or provide shape to (including dynamic shape such as may be accomplished, for example, by the use of thermally sensitive shape alloys) the laden substrate or the multifunctional material. The configuring material may also encapsulate the laden substrate or the multifunctional material, provide lubrication to the laden substrate or the multifunctional material, provide dimensions such as volume or shape by filling in the space surrounding the laden substrate or the multifunctional material, provide shock absorption (mechanical or electrical shock) to the laden substrate or the multifunctional material, provide electrical conductivity to the laden substrate or the multifunctional material, provide electrical connectivity to the laden substrate or the multifunctional material, provide or enhance exposure of the laden substrate or multifunctional material, or provide aesthetic or pleasingly functional features such as color to the laden substrate or the multifunctional material (such as use in color coding).

Examples of configuration materials that may be used as encapsulants include, but are not limited to the following: a single layer of silicon oxide based glass (5 μm), teflon (10 μm), parylene (6 μm), low-density polyethylene (25 μm), or polyacrylate (25 μm); or a multilayer plastic coating of parylene (2 μm)/Ti (500 Å)/parylene (2 μm)/Ti (500 Å)/parylene (2 μm)/Ti (500 Å). Some substitutes for titanium in a multilayer plastic coating may include Al, Cr, Al₂O₃, or Cr₂O₃. The thicknesses described above are exemplary only.

Configuration materials may provide one or more beneficial properties by means of a single material or a plurality of materials. Some examples of configuring materials that may be used in a matrix for the substrate include, for example, insulating or conducting polymer or polymer base, resin, ceramic, glass, metal, metal alloy, carbon, or carbon compounds.

In one embodiment, the laden substrate may include a thin-film battery functional pattern. In such an embodiment, the certain configuring materials used as a matrix in the multifunctional material may have beneficial properties. Examples of these materials include, for example, an insulating polymer, insulating polymer base, conducting polymer, conducting polymer base, resin, ceramic, glass, metal, metal alloy, carbon, carbon compound, bismaleimide-SiO₂, silicones, parylene, parylene multilayered with inorganics, polyacrylate, polyacrylate multilayered with inorganics, rubber, thick vacuum deposited air-insensitive inorganics, thick vacuum deposited lithium phosphorous oxynitride (“Lipon”), polymer, metal film, metal foil, metal alloy film, metal alloy foil, insulating adhesive, conductive adhesive, dielectric adhesive, and dielectric. Matrix materials may be applied, for example, by infiltration of liquid, resin, or gel. Additionally, the matrix materials may be applied by lamination of sheet matrix materials. Electrochemical encapsulation matrices may also be vacuum deposited on a portion of each substrate, monolayer of substrates, or preform of substrates.

Some examples of configuring materials that may be useful to promote conductivity in the composite material include, for example, a polymer, ceramic, glass, metal or metal alloy film or foil, with an insulating or conductive bonding adhesive. In certain circumstances, a particular adhesive may also function as dielectric, or may be combined with a suitable dielectric by, for example, placing a layer of dielectric between two layers of adhesive. This may result in a composite material that has certain desirable capacitative properties.

The configuration material may, for example, provide electrical connections to portions of the functional thin-film pattern on the substrate. In the specific example of a battery pattern, the electrical connection may, for example, be made to the cathode or anode terminals. In some embodiments, it may be desirable to employ multiple batteries on a single substrate, connecting each of the cathodes to each other and connecting each of the anodes to each other, creating a parallel connection. Alternatively each anode may be connected to the cathode of another battery, thus creating a series connection. Hybrid series-parallel connections are also permitted.

The configuration material may be applied to an individual substrate, or substrates that are interconnected or interwoven. Additionally, configuration materials may be applied to substrates that are in a monolayer or have been preformed by casting.

Examples of configuration materials that may be suitable for reinforcement include, for example, a cylindrical fiber, a ribbon or strip, a square or rectangular ribbon or strip, a monofilament, wire, or rod of carbon or carbon compound, a conducting or insulating polymer, resin, glass, ceramic, metal, or metal alloy including shape memory alloy. The diameter of a configuring material for use as a reinforcing material may preferably be between about 1 micron and about 0.25 inches, but may be more preferably between about 10 microns and about 0.025 inches. When the reinforcing material comprises a square or rectangular ribbon or strip, the cross-sectional lengths of the sides (height or width of the substrate) may preferably be between about 1 micron and about 5 inches, but may be more preferably between about 10 microns and about 0.25 inches.

The substrate may be configured by or with other substrates in such useful patterns as, for example, in parallel, alternating layer transverse, perpendicular, wound, woven, bundled, braided, or monolayered. The configuration material may be combined with the substrate by means of, for example, casting, compressing, extruding, molding, impregnating, winding, linear/alternating-transverse or coil preforming, roll-compacting, laminating, bonding, or as previously discussed, braiding or weaving. Final integrated power composite structural materials, defined by application design, may finally be interconnected electronically and electrochemically. Integrated composite materials may be mechanically fastened, sewn, bonded or laminated, for example, into a final product form.

In one embodiment of the present invention, a substrate with thin films may be incorporated into a multifunctional material. This may be accomplished directly, as described previously, or may be incorporated by some intermediate means. This intermediate means may include, for example, coating the substrate or removing portions of the substrate. Alternatively, the substrate may be used to form composite materials. The composite material may, for example, be a flexible material such as a fabric, or may be rigid. In an embodiment in which a rigid material is desired, the rigidity may be achieved by suitably arranging the substrate. For example, a tightly woven substrate may produce a more rigid composite than a loosely woven substrate. In other instances, the substrate may inherently provide rigidity, such as by incorporating a thick metallic, ceramic, or glass fiber in the substrate. In other embodiments, the rigidity may be achieved by the other components of the composite. The other components may, for example, include resins, alloys, textiles, or rubber.

Patterning methods may be applied to laden substrates or to laden substrates with configuration material. These techniques may, for example, include laser ablation, laser scribing, or chemical or mechanical etching. Additionally, photolithographic film masking, if utilized, may involve chemical or e-beam lithographic means for removal of the photoresist after each deposition. Avoiding damage to the substrate may present some challenges in these situations. Applying one or more of these patterning methods may permit access to layers that are inaccessible or difficult to access otherwise.

It is an object of the present invention to permit the thin-film deposited lithium-based batteries on fibrous, ribbon-like or strip-like substrates to be integrated into multifunctional materials.

It is a further object of the present invention to provide a multifunctional composite material, the form of which may take any shape.

It is a more specific object of the present invention to provide a multifunctional composite material, the form of which may be a woven fabric.

It is another object of the present invention to provide a multifunctional composite material, the form of which may be a braided rope or yarn.

It is another object of the present invention to provide an integrated power multifunctional composite material in the form of a fiber, ribbon, or strip, preferably flexible, reinforced with a single layer or a multilayer of battery fibers, ribbons, or strips.

It is yet another object of the present invention to provide an integrated power multifunctional composite material in which electrochemical cell components provide about 0.1 to about 90 percent fractional volume of the composite.

It is another object of the present invention to provide a consolidated integrated power multifunctional composite material through casting, compressing, extruding, molding, impregnating, winding, linear/alternating-transverse or coil preforming, roll-compacting, laminating, or bonding.

It is another object of the present invention to provide an integrated power multifunctional composite material in which the composite matrix material may be an insulating or conductive polymer or polymer base, resin, ceramic, glass, metal, metal alloy, carbon, or carbon compound.

It is another object of the present invention to provide an integrated power multifunctional composite material in which the composite matrix material may have valuable properties for use in battery encapsulation, such as, for example, Bismaleimide-SiO2, silicones, parylene, parylene multilayered with inorganics, polyacrylate, polyacrylate multilayered with inorganics, rubber, resin, thick vacuum deposited air-insensitive inorganics, or Lipon.

It is another object of the present invention to provide an integrated power multifunctional composite material in which the composite matrix material may include one or more of the following: a polymer, ceramic, glass, metal or metal alloy film or foil with an insulating or conductive composite bonding adhesive.

It is another object of the present invention to provide an integrated power multifunctional composite material that employs a conductive composite matrix as the cathode or anode terminal or electrical connection of the integrated fiber, ribbon, or strip reinforced power source.

It is another object of the present invention to provide an integrated power multifunctional composite material that allows the application of composite matrix material to be made to individual fibers, ribbons, or strips, a monolayer of the battery substrates, or a casting preform of the battery substrates.

It is another object of the present invention to provide an integrated power multifunctional composite material in which one or more reinforcement substrates is a cylindrical fiber, a ribbon or strip, a monofilament, a wire, or a rod, and has a diameter of between about one micron and about 0.25 inches.

It is another object of the present invention to provide an integrated power multifunctional composite material in which one or more reinforcement substrate is a cylindrical fiber, a ribbon or strip, a monofilament, a wire, or a rod, and has a diameter of between ten microns and about 0.025 inches.

It is another object of the present invention to provide an integrated power multifunctional composite material in which one or more reinforcement substrates is a square or rectangular ribbon or strip of a material, such as carbon, a carbon compound, a conducting or insulating polymer, a glass, a resin, a ceramic, a semi-conductor, a metal, or a metal alloy including a shape memory alloy or a super-conducting alloy.

It is another object of the present invention to provide an integrated power multifunctional composite material in which one or more reinforcement substrates is a square or rectangular ribbon or strip of material having cross-sectional sides between about 1 micron and about 5.0 inches.

It is another object of the present invention to provide an integrated power multifunctional composite material in which one or more reinforcement substrates is a square or rectangular ribbon or strip of material having cross-sectional sides between about 10 microns and about 0.25 inches.

It is another object of the present invention to provide an integrated power multifunctional composite material that includes a vacuum deposited lithium-based, solid-state, thin-film battery on a reinforcement fiber.

It is another object of the present invention to provide an integrated power multifunctional composite employing one or more conductive reinforcement substrates as single or multiple cathode or anode battery terminals, or mechanical or electrical connections of the integrated fiber, ribbon, or strip reinforced power source.

It is another object of the present invention to provide an integrated power multifunctional composite material utilizing a configuration or layup of reinforcing battery fibers, ribbons, or strips within a structural composite. These layups may include, for example, parallel, alternating layer transverse, perpendicular, wound, woven, bundled, monolayered, or any combination of these or similar arrangements.

It is another object of the present invention to provide an integrated power multifunctional composite material. The method of providing this material may involve utilizing a means of exposing deposited battery anode or cathode current collectors for subsequent contact. This means for exposing current collectors may be accomplished, for example, by any chemical, etching, laser scribing, photolithographic, thin-film patterning, or mechanical technique.

It is an object of the present invention to provide a method of reinforcing a fiber upon which a lithium-based, solid-state, thin-film battery has been deposited.

It is an object of the present invention to provide a method of producing a multifunctional material that includes integrated power. The multifunctional material may include a reinforcement material that provides electrical or mechanical connections to the power source.

It is an object of the present invention to provide a multifunctional material that is composed of electrochemical cell components in about 0.1 to about 90 percent by volume.

It is an object of the present invention to provide a means of providing electrical connections to multifunctional composite materials that include a power supply.

It is an object of the present invention to provide materials that may be used for fabric, garments, or clothing. These garments or clothing may be created by sewing fabric manufactured by the method of the present invention. A preferred method of combining the substrate with a configuring material for this purpose is weaving.

It is an object of the present invention to provide arrays of multifunctional materials. For example, one may select as a substrate an optical fiber that has at least two segments. In the first segment, the optical fiber may function normally with respect to providing near total internal reflection of light waves. In the second segment, the optical fiber may behave “poorly,” allowing a large fraction, or all of the light, to escape. A thin-film photovoltaic device arranged in an inverted pattern may be applied to the second segment. Additionally, a thin-film battery may be applied on a portion of the first segment. The resulting solar cell and battery combination may be repeated many times on many optical fibers. These fibers may then be tightly bundled and electrically interconnected to provide a highly efficient solar energy module.

It is an object of the present invention to provide materials that may be arranged to provide aerospace composites. These composites may include cast or otherwise pre-formed fuselage, wing, tail, nose, or combinations thereof, but are not limited to such use. In particular, micro-aircraft, for which reduced weight and a quiet power supply may be valuable, may particularly benefit from the multifunctional materials of the present invention. Other applications, such as firearms, may benefit from power-bearing materials to supply power while simultaneously providing structural functionality.

It is understood that both the foregoing general description and the following detailed description are exemplary and explanatory only and are not restrictive of the invention as claimed. The invention is described in terms of thin-film electrochemical devices on fibrous or ribbon-like substrates; however, one skilled in the art will recognize other uses for the invention. The accompanying drawings illustrating an embodiment of the invention together with the description serve to explain the principles of the invention.

### BRIEF DESCRIPTION OF THE DRAWINGS

FIG. 1 is a depiction of an embodiment of the present invention employing a plurality of laden substrates connected together

FIG. 2 is a cross sectional diagram of a preferred embodiment of the present invention.

FIG. 3A is a perspective rendering of a preferred embodiment of the present invention.

FIG. 3B is a perspective rendering of a preferred embodiment of the present invention.

FIG. 4 is a photograph of a twisted embodiment of a monotape of the present invention.

FIG. 5A is a side view of a monotape of the present invention.

FIG. 5B is a cutaway diagram of a multilayer stacking of several monotapes of the present invention corresponding to the monotape depicted in FIG. 5A.

FIG. 6A is a side view of a monotape of the present invention.

FIG. 6B is a cutaway diagram of a multilayer stacking of several monotapes of the present invention corresponding to the monotape depicted in FIG. 6A.

FIG. 7 is a perspective view and magnification of an embodiment of a monolayer monotape of the present invention.

FIG. 8 is a depiction of three preferred embodiments of the present invention.

FIG. 9 is a perspective view and close-up of a woven integration of substrates according to the present invention.

FIG. 10 is a graph of the performance of an embodiment of the present invention in terms of discharge capacity in microampere-hours with respect to number of charge-discharge cycles.

FIG. 11 is a graph of the performance of an embodiment of the present invention in terms of voltage with respect to discharge capacity measured in microampere-hours.

### DETAILED DESCRIPTION OF THE INVENTION

It is to be understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “a layer” is a reference to one or more layers and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise. The use of the term fibrous in describing substrates should be understood to include traditional fibrous substrates including those with circular, elliptical, and irregular shapes, as well non-traditional fibrous substrates such as those that are ribbon-like or strip-like. The invention is described in terms of thin-film deposition on fibrous or ribbon-like substrates; however, one of ordinary skill in the art will recognize other applications for this invention including, for example, applications in confection and pyrotechnics.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. All references cited herein are incorporated by reference herein in their entirety.

Creation of a laden substrate may be accomplished by a variety of techniques. U.S. patent application Ser. No. 10/109,991 describes a method that facilitates deposition of multiple and multi-functional vacuum thin films sequentially and selectively on cylindrical and fibrous, ribbon-like, or strip-like substrates. The design of that invention may be exemplified by an embodiment in which a thin film battery is deposited on a substrate. The shape of the patterns on the substrate may be controlled by means of a shadow mask. This substrate may also perform a secondary purpose; for example, the substrate may comprise an optical fiber. The invention may produce thin film devices that may be used in a wide variety of applications.

The methods of deposition disclosed in U.S. patent application Ser. No. 10/109,991, and U.S. patent application Ser. No. 60/318,321 may permit the deposition of thin film devices on substrates which are not required to meet strict rigidity requirements. Those applications disclose methods that permit the deposition of, for example, selectively and/or systematically patterned thin film devices, which may be multilayered. Certain embodiments of those inventions include synthetic multi-functional materials such as thin film batteries on such substrates as optical fiber, super-conducting or shape memory substrates. These resultant multifunctional materials may have a wide array of uses including, for example, battery-amplified waveguides/optical fibers, power-generating fabrics, micro-airborne vehicles, and firearms.

One embodiment of the invention described in U.S. patent application Ser. No. 10/109,991 includes a means of shadow masking a substrate and a means for positioning a substrate. This embodiment may also include a means for moving a substrate. The means of shadow masking may comprise a sleeve or tubular member having an interior and exterior diameter. Thus, the means for shadow masking may be referred to as a tubular member. The means for shadow masking may also be viewed as a barrier having an aperture or orifice. In such a situation, the barrier corresponds to the tubular member, and the aperture is an opening or hole in the barrier.

As described in U.S. patent application Ser. No. 10/109,991, the size and shape of the interior diameter (or aperture) of such a tubular member may be selected to roughly match the shape of a cross-section of a chosen substrate. For example, the shape may be round, square, rectangular or elliptical. While these shapes are examples, any shape including irregular shapes and dynamic shapes are permitted. Examples of dynamic shapes of a cross-section of a substrate may include changes in shape over time, due to the deposition process, or due to temperature, pressure, or tension changes, as well as changes (i.e., differences) in the shape of a substrate's cross-section at different selected points along the length of the substrate.

As described in U.S. patent application Ser. No. 10/109,991, the means of masking may include two or more tubular members separated by a distance. Additionally, if a plurality of tubular members mask the same substrate, it may be preferable that the interior diameters of these members be roughly coaxial. This may allow a flexible substrate to be coated in an unflexed position, which may provide for a greater range of flexibility after deposition. In situations in which the substrate has an unflexed shape that differs from a straight line, for example, a substrate that is arc-shaped unflexed, a plurality of tubular members may preferably be placed to allow the substrate to remain unflexed. In other situations, tension or compression forces in the substrate may permit the use of coaxially aligned tubular members, which may be preferable in situations in which the shape of the substrate is readily deformable, such as, for example, where the substrate is an optical fiber.

As described in U.S. patent application Ser. No. 10/109,991, when a pair of coaxial tubular members is used, the gap defined by the separation of the tubular members may be the deposition area. In other situations, the deposition area may be defined by the area traversed by the substrate between any two tubular members. In a situation in which only one tubular member is used, the deposition area may be the area approaching the tubular member.

Moreover, as described in U.S. patent application Ser. No. 10/109,991, the means for shadow masking may also comprise means for changing the size of the deposition area. This may be accomplished, for example, by producing relative motion of the shadow mask. For instance, a tubular member may be moved relative to the substrate or to another tubular member. In a preferred embodiment, the relative motion is accomplished by moving each tubular member while keeping the substrate in a fixed location; however, one may move, for example, one tubular member and the substrate while leaving the other tubular member in a fixed location.

As described in U.S. patent application Ser. No. 10/109,991, the motion of the tubular members may be accomplished, for example, by providing an index to which the members may be aligned. This index may be continuous or discrete. Moreover, the index may be a mechanical index, an electronic index, an optical index, or a hybrid index.

As described in U.S. patent application Ser. No. 10/109,991, the means for positioning a substrate may further include a means for holding a substrate. For example, it may be useful to attach a substrate that exhibits a significant amount of deflection from a desired position to a means for providing tension in the substrate, such as a spring means or an anchor member. The substrate may also be held, for example, by a support member having a specific coefficient of friction. The specific coefficient of friction may be selected so as to encourage the substrate to remain in substantially the same place. The support member may be located, for example, so that the substrate rests on the support member when the substrate is oriented horizontally.

As described in U.S. patent application Ser. No. 10/109,991, the means for positioning the substrate may further include a means for rotating the substrate about an axis. Rotating the substrate about an axis may provide the benefit of more uniform deposition on the substrate. The means for rotating may comprise, for example, a substrate holding member and a means for rotating the substrate holding member. This substrate holding member may be combined with the means for holding the substrate and the means for providing tension. Additionally, the substrate holding member may also include the means for restraining the axial motion of the substrate.

As described in U.S. patent application Ser. No. 10/109,991, a means for rotating the substrate may include, for example, a hub. This hub may be provided with a single point of connection in the case of a single substrate, or with multiple connections in the case of multiple substrates. Thus, a hub may perform the functions of positioning the substrate, restricting the substrate's coaxial motion, and rotating the substrate. A positionable mask with apertures adjusted to the size of the substrate may be used as an example of a tubular member. The hub may be provided, for example, with a plurality of cylindrical members parallel to the axis of the substrate. The mask may be provided with corresponding openings that closely fit the cylindrical members on the hub. Thus, the mask may be slideably positioned on the hub. In a particular embodiment, the cylindrical members may be provided with irregularities in diameter corresponding to indexed positions. Thus, the cylindrical members may be used as means for mechanical indexing. The hub may be connected, for example, to a drive shaft by means of a pair of miter gears. The miter gears may provide the means for translation of rotational motion. A second hub and mask assembly may be positioned coaxially to and mirroring the first hub and mask assembly. This hub may also be connected to the drive shaft by means of miter gears. Finally, the length of the drive shaft may be adjusted to permit adjustments in the distance between the hub and mask assemblies; thus, the size of the deposition area may be varied.

As described in U.S. patent application Ser. No. 10/109,991, functional patterns may be described in terms of a discretely indexed deposition process. Discrete indexing may not be necessary, but may provide the benefit of consistent results in output. The index used is preferably an ordinal index, based on a length-wise view of a cross section of a substrate. The index, from left to right along the length of the substrate, may start at L4 and then proceed to L3, then to L2, then to L1. These indexing positions may be followed by R1, then R2, next R3, and finally R4. There is no requirement that there only be eight indexed positions, or that the number of indexed position on the left and right be equal. Moreover, the difference in position between any two consecutive indexed positions may be different from the difference between the position of two other consecutive indexed positions. In one example, L4 is separated from L3 by about 0.25 inches, L3 is separated from L2 by about 0.25 inches, and L2 is separated from L1 by about 0.25 inches. Thus, the interposition separation of L1, L2, L3, and L4 is 0.25 inches. In this example, R4 is separated from R3 by about 0.25 inches, R3 is separated from R2 by about 0.25 inches, and R2 is separated from R1 by about 0.25 inches. Thus, the interposition separation of R1, R2, R3, and R4 is 0.25 inches. Finally, the distance between L1 and R1 may be between approximately 2.0 inches and approximately 7.0 inches.

As described in U.S. patent application Ser. No. 10/109,991, and U.S. patent application Ser. No. 60/318,321, in the example of a lithium-free battery, the substrate may include, for example, an alumina fiber. The first layer to be deposited may be a cathode current collector. This cathode current collector layer may include, for example, chromium. The cathode current collector layer may be deposited between L1 and R4. Next, the cathode layer may be deposited. The cathode layer may include, for example, amorphous Li_{1.6}Mn_{1.8}O₄ and may be deposited between L1 and R1. Next, the electrolyte layer may be deposited. The electrolyte layer may include, for example, Lipon and may be deposited between L2 and R2. Next, an electrode layer, which in this instance -provides an auxiliary anode layer and anode current collector, may be deposited. The electrode layer may include, for example, copper and may be deposited between L4 and R1. Next, the protectant layer may be deposited. The protectant layer may include, for example, Lipon and may be deposited between L3 and R3.

As described in U.S. patent application Ser. No. 10/109,991, and U.S. patent application Ser. No. 60/318,321, in the example of a buried lithium-free battery, the substrate may include, for example, an alumina fiber, a copper fiber, or a glass fiber. The first layer to be deposited may be an anode current collector. This anode current collector layer may include, for example, chromium and may be deposited between L4 and R4. Next, the electrolyte layer may be deposited. The electrolyte layer may include, for example, Lipon and may be deposited between L3 and R3. Next, the cathode layer may be deposited. The cathode layer may include, for example, amorphous Li_{1.6}Mn_{1.8}O₄ and may be deposited between L1 and R1. Next, an electrode layer, which may be used to provide an auxiliary cathode layer, may be deposited. The electrode layer may include, for example, chromium and may be deposited between L1 and R1. Next, a cathode current collector layer may be deposited. The cathode current collector layer may include, for example, copper and may be deposited between L1 and R1.

One example of multifunctional materials taught in the present invention is a power composite with a fiber substrate. Such power composites may be customized in several ways. The power storage or generation capacity of the fiber may be customized by, for example, adjusting the thickness of the multilayer functional thin-film pattern including, for example, the thickness of individual layers. The total power capacity may also be altered by adjusting the density of the fibers with functional power patterns in relation to other materials in the composite. Additionally, the structural characteristics of the composite may be altered by adjusting the thickness, shape, or length of the fibers. When more than one device is deposited along the fiber's length, the fraction of the fiber that is covered with a patterned deposition may also effect the structural characteristics of the composite material.

In one embodiment of the present invention, successful integration of solid-state, lithium-based, thin-film fibrous, ribbon-like, and strip-like batteries within, for example, polymer matrices has been demonstrated in multifunctional composite materials. By utilizing the cylindrical geometry of a fiber, for example, the increased surface area available for thin-film functional patterns enables greater capacities within structural material volumes. The volume fraction of electrochemical battery components may be tailored based on the desired structure of the power composite, thereby permitting functional pattern designs suited to specific structural material requirements.

The multifunctional material with power storage and/or creation capabilities may have many applications including military applications, commercial applications, and exoskeleton power structures in, for example, robotics, airborne operations, and munitions operations. These resultant multifunctional materials may also have a wide array of other uses including, for example, battery-amplified waveguides/optical fibers, power-generating fabrics, micro-airborne vehicles, and firearms.

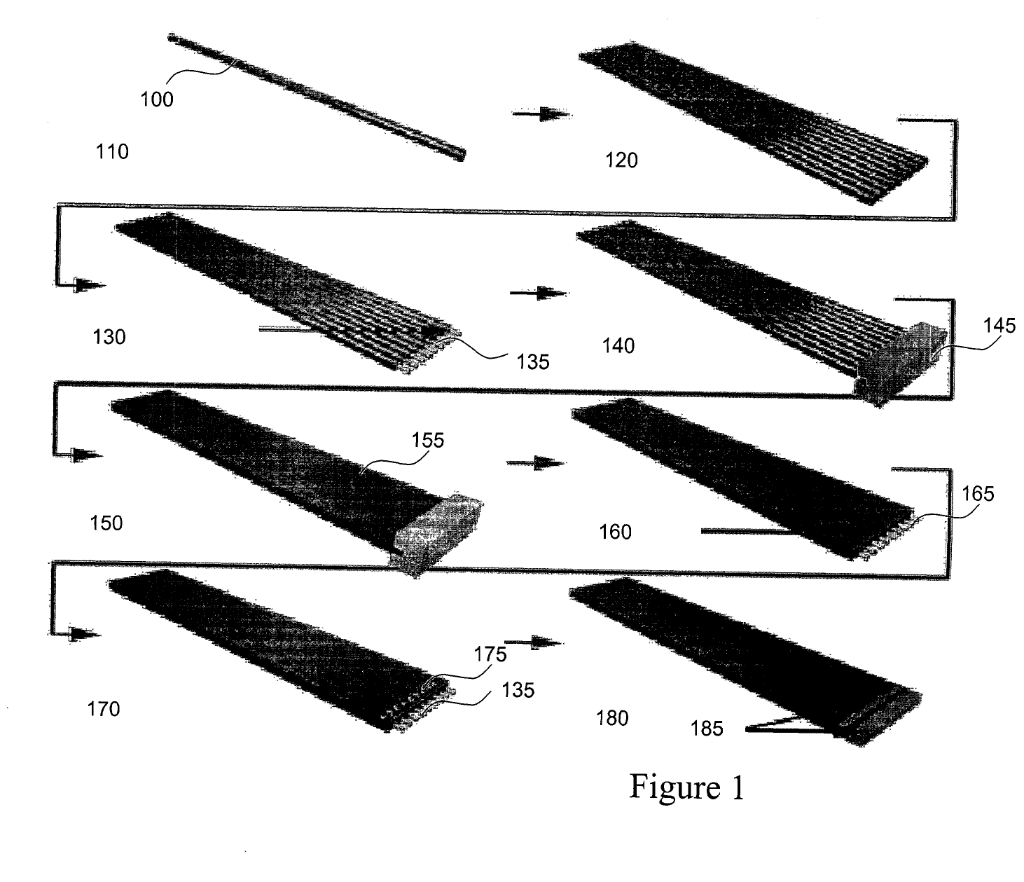

FIG. 1 depicts an embodiment of the present invention employing a plurality of laden substrates connected together. This figure shows the substrates connected in parallel, although series and hybrid connections are also allowed. FIG. 1 shows one embodiment for electrically connecting a plurality of laden substrates 100 that have one or more batteries on each substrate 100, to one another, thereby increasing the overall capacity or the overall voltage or both. A parallel connection, which yields greater capacity at the same voltage, may be accomplished by connecting the cathode current collectors (ccc's) of all batteries to one another. A series connection may be accomplished by connecting each ccc to the anode current collector (acc) of the adjacent battery. In frame 110, a single laden substrate 100 with deposited functional pattern is shown. Although this embodiment depicts an example in which the laden substrate has a battery as its thin-film functional pattern, many other patterns are permitted. Some examples of other types of functional patterns include photovoltaic cells and multilayer microcircuit interconnects. In frame 120, several individual laden substrates 100 are shown laid parallel to one another. It is not necessary that the substrates be exactly parallel. Indeed, although the resultant product will take on a different appearance and have different structural characteristics, the laden substrates may also, for example, be braided, enmeshed or woven together. Frame 130 shows the laden substrates 100 with an electrical contact layer 135 exposed. The electrical contact layer 135 may be exposed by, for example, etching the laden substrates 100. The etching may be accomplished by mechanical, chemical, laser, or other means. Additionally, the process used in lading the substrates may provide an exposed electrical contact layer (that is to say, they may be made this way). In frame 140, a protective clamp 145 is placed over the exposed electrical contact layer 135. A clamp is not required but may obviate subsequent removal of unwanted configuring material. Additionally, the clamp may provide the benefit of maintaining the relative position of the laden substrates (i.e., the layup) while the configuring material is being added. In frame 150, a matrix 155 may be added, for example, to maintain the relative position of the substrates 100, or, for another example, for ease of handling. The matrix material may, for example, be bismaleimide-SiO₂, rubber, polyacrylate, polyacrylate layered with organics, or glass. A very wide range of materials may be used, and the particular choice of material will depend on the desired characteristics of the multifunctional material. In frame 160, the protective clamp 145 may be removed from the electrical contact layer 135. Alternatively, the protective clamp may be left in place and may serve as an additional configuring material; however, in the present example, removing the clamp re-exposes the previously exposed electrical contacts, and thus, in certain circumstances, may be beneficial. As shown in frame 170, additional electrical contacts 175 may be exposed as needed. These contacts may, for example, be exposed by a scribing process. The process used to expose the contacts may substantially depend on the choice of matrix configuring material selected. Finally, in frame 180, leads 185 may be connected to the previously exposed electrical contacts. In certain embodiments, the exposed contacts, positioned by the configuring material, may be used without connecting electrical leads. An example of a leadless connection may include plugging the exposed contacts into suitably adapted female power connector.

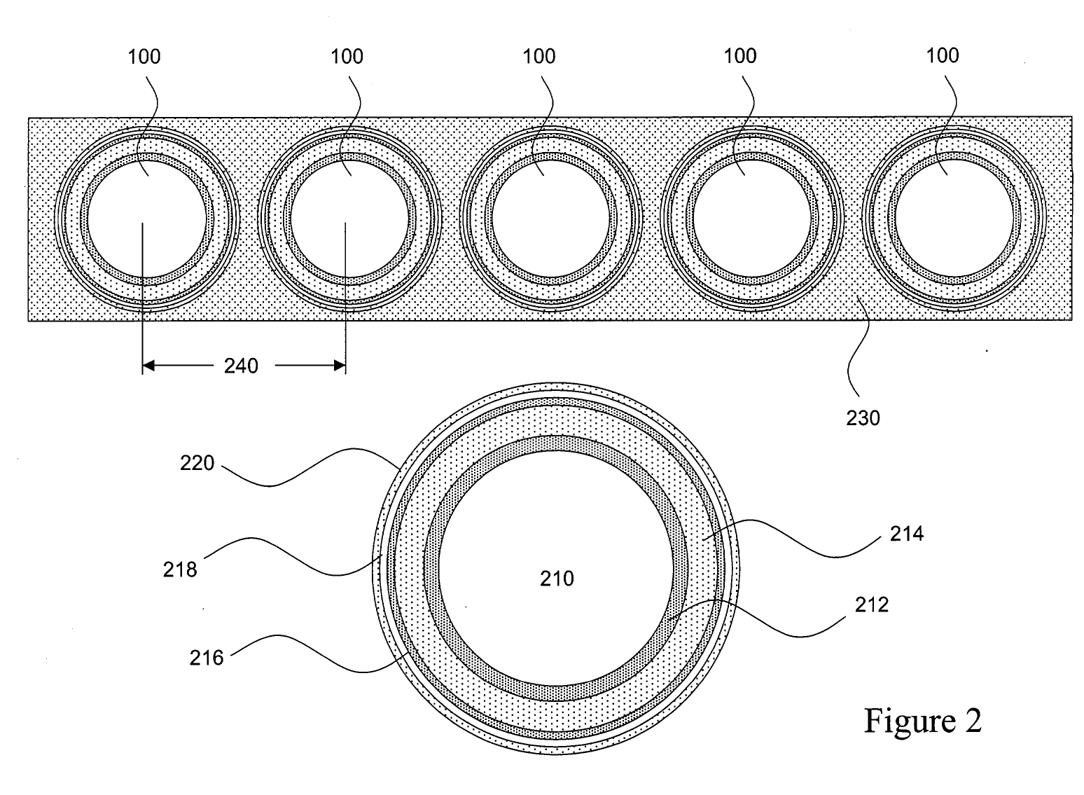

FIG. 2 is a cross sectional diagram of an embodiment of the present invention. Shown in this diagram are laden substrates 100 with a 100 micron copper fiber substrate 210, or core. A conductive core may serve a function related to that of the functional pattern by, for example, providing a current collector. In other embodiments, a conductive core may have additional insulating layers or alternating insulating and conductive layers. In these embodiments, the core may also provide unrelated or marginally related functions such as providing a communications path. In certain embodiments, the two functions (the function of the functional pattern and the function of the substrate) may be inter-related, as for example, when a functional pattern is used to boost, filter, or otherwise alter or augment a signal in the substrate. In the embodiment depicted in FIG. 2, electrochemical cell multilayers were deposited using a shadow-masking patterning technique. An example of a shadow masking patterning technique and apparatus for producing a functional pattern by means of a shadow mask are described in U.S. patent application Ser. No. 10/109,991, which is hereby expressly incorporated herein by reference, in its entirety. Other techniques for depositing multilayers are also permitted, and may, for example, include chemical bath deposition. As shown in FIG. 2, a 1.0 micron layer 212 of Li_{1.6}Mn_{1.8}O₄ was deposited on the copper substrate 210. Next, a 2.0 micron layer 214 of Lipon was deposited on the Li_{1.6}Mn_{1.8}O₄ layer 212. Then, a 0.01 micron layer 216 of Sn₃N₄ was deposited on the Lipon layer 214, and a 0.3 micron layer 218 of copper was deposited on the Sn₃N₄ layer 216. A 0.3 micron layer 220 of Lipon was deposited on the copper layer 218. Each of these laden substrates 100 was subsequently encapsulated in a Bismaleimide-SiO₂ matrix 230. Other functional patterns may also be provided on the substrate. Examples of additional patterns are described in U.S. Provisional Patent Application 60/318,321, which is hereby expressly incorporated herein by reference, in its entirety. In the present embodiment, the laden substrates have been positioned substantially parallel to one another, however, other relative position schemes are allowed. The separation 240 between the centers of adjacent laden substrates may, for example, be 0.011 inches as shown here. The close proximity of laden substrates shown permits a large fractional volume of power producing material compared to the total volume of the multifunctional material. A lower density of laden substrates may provide a different structural result, referred to as monotape. The monotape may be produced by combining laden substrates in a matrix. Generally, a monotape will also have the characteristic of having a single layer of laden substrates, but alternatively may have a small number of layers. The product of a process involving a large number of layers of laden substrates may be referred to by the more general term “composite” which also encompasses a monotape as a subset.

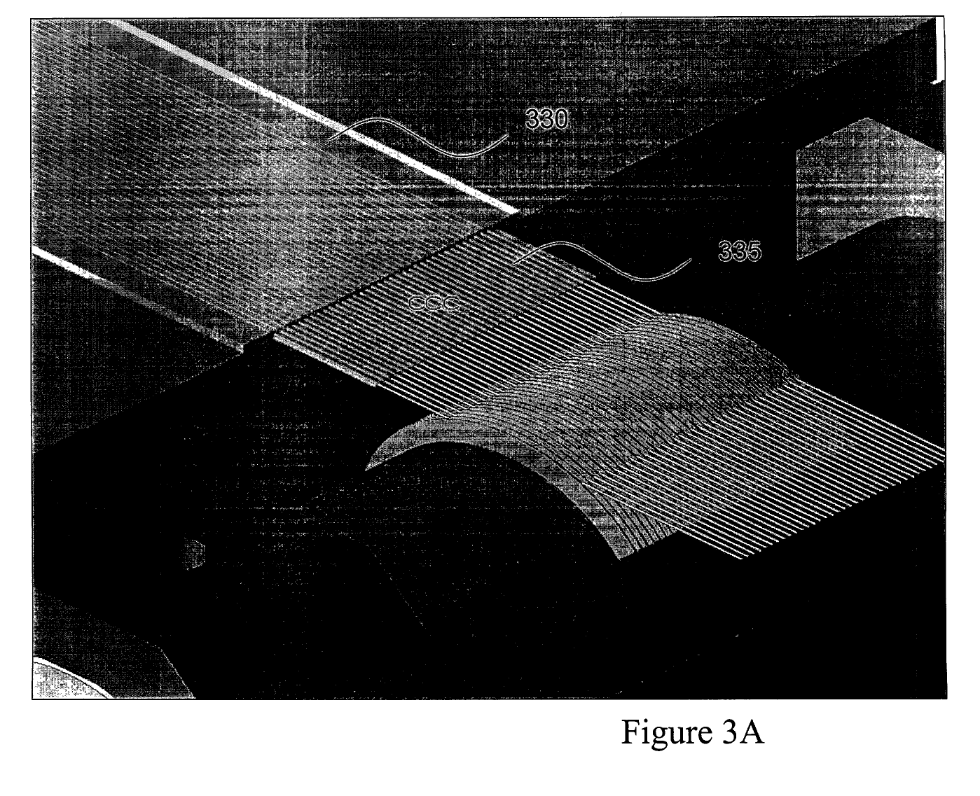

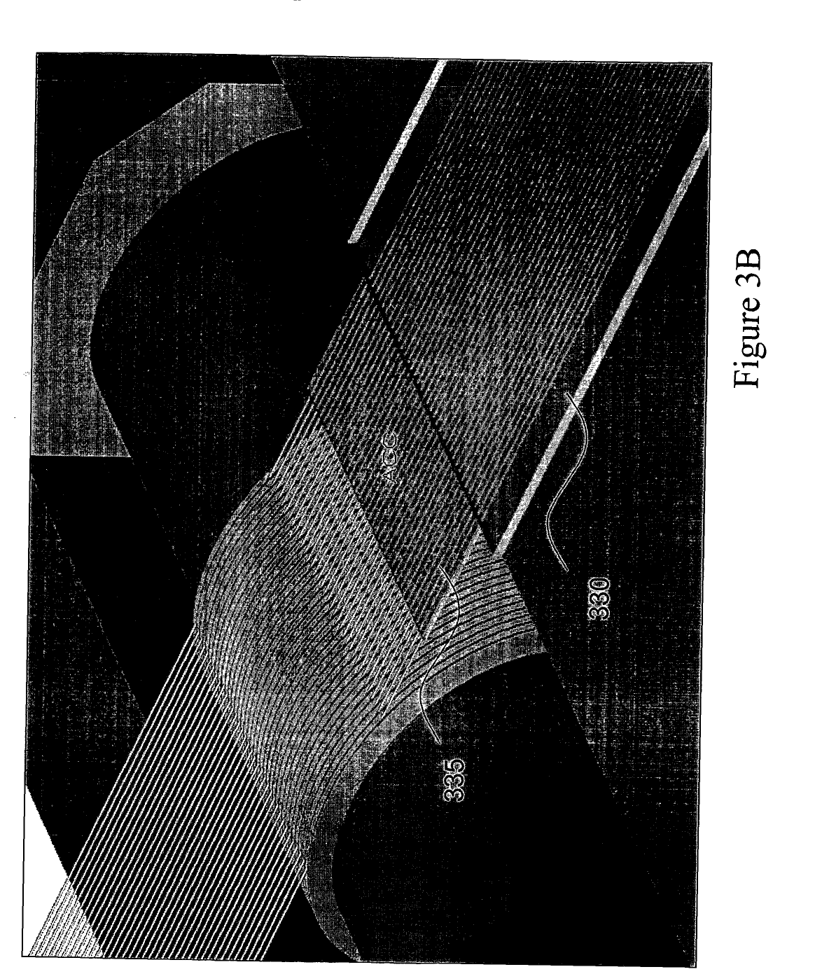

FIGS. 3A and FIG. 3B are perspective renderings of a preferred embodiment of the present invention. FIG. 3A provides an example of ccc termination, and FIG. 3B provides an example of acc termination. Fibrous batteries may be fixed in linear alignment with equal spacing in monolayer configuration. Spacing between laden substrates, in this example, is about 0.011 inches and is provided by centers. In general, the desired integrated power capacities and structural properties will dictate preferred spacing between battery substrates in, for example, linear, alternating transverse, multilayered, preformed, wound, and woven applications. The figures depict, for example, a monotape consolidation and illustrate the electrical terminations. In this embodiment, Bismaleimide-SiO₂ 330 is utilized as a polymeric, flexible, battery encapsulating matrix. Applied in liquid form, a matrix material (in the present example, Bismaleimide-SiO₂ 330) may be subsequently compressed between release lining material (not shown) and cured to hardness and pliability through a thermal bake. A matrix material may also be applied by laminating sheet matrix materials. Additionally, electrochemical encapsulation matrices may be vacuum deposited on portions of each substrate. A conducting matrix 335 containing silver (Ag) may be subsequently applied at appropriate termination points of the ccc's and acc's. In this example, the conducting matrix 335 may be applied across all composite battery fibers to enable parallel multiple fiber battery charging and discharging. In this particular symmetric thin-film patterned embodiment there are two positions of each ccc and acc available.

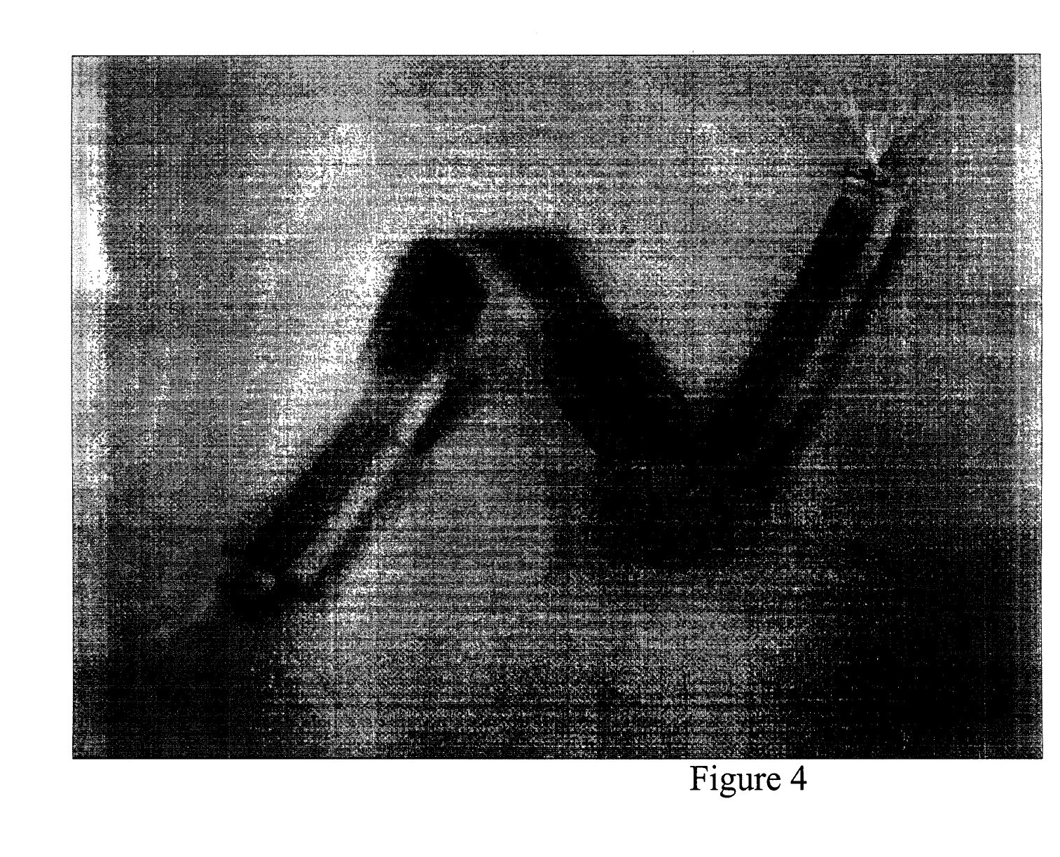

FIG. 4 is a photograph of a twisted embodiment of a monotape of the present invention. This photograph depicts a monotape integration of twenty Li-ion fiber battery laden substrates within the composite multifunctional material. These laden substrates are surrounded by a matrix. In this embodiment, the resultant monotape is flexible; however, the monotape may be rigid in other embodiments if that is the desired structural characteristic.

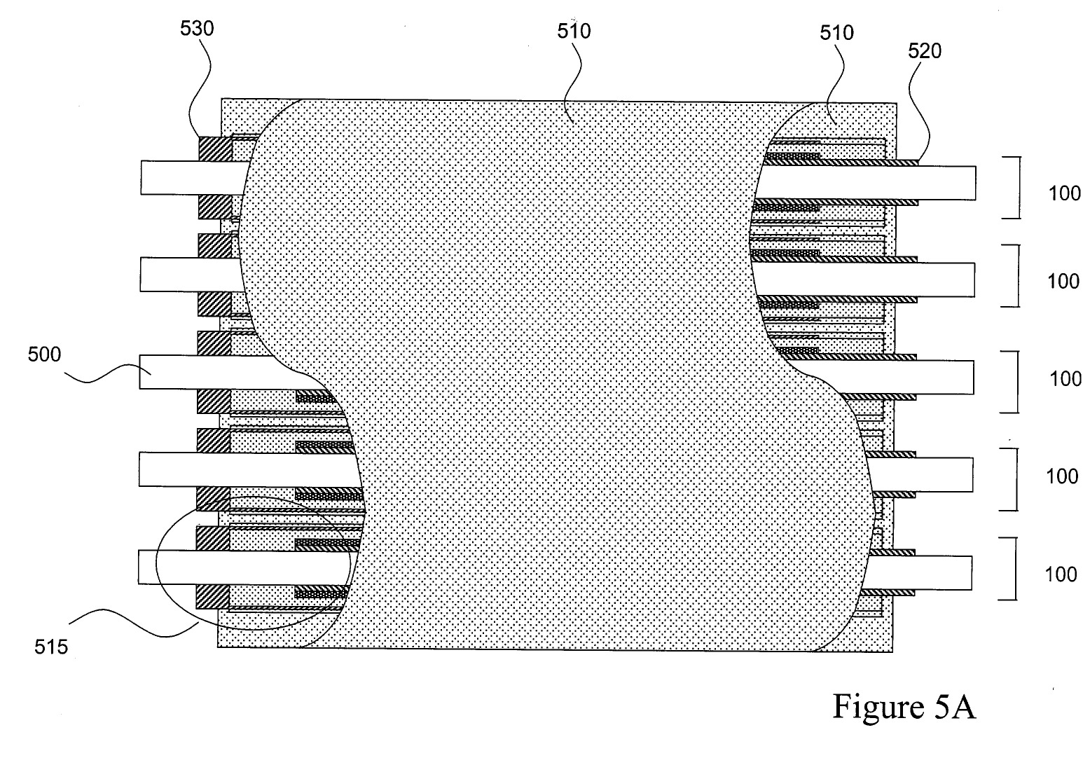

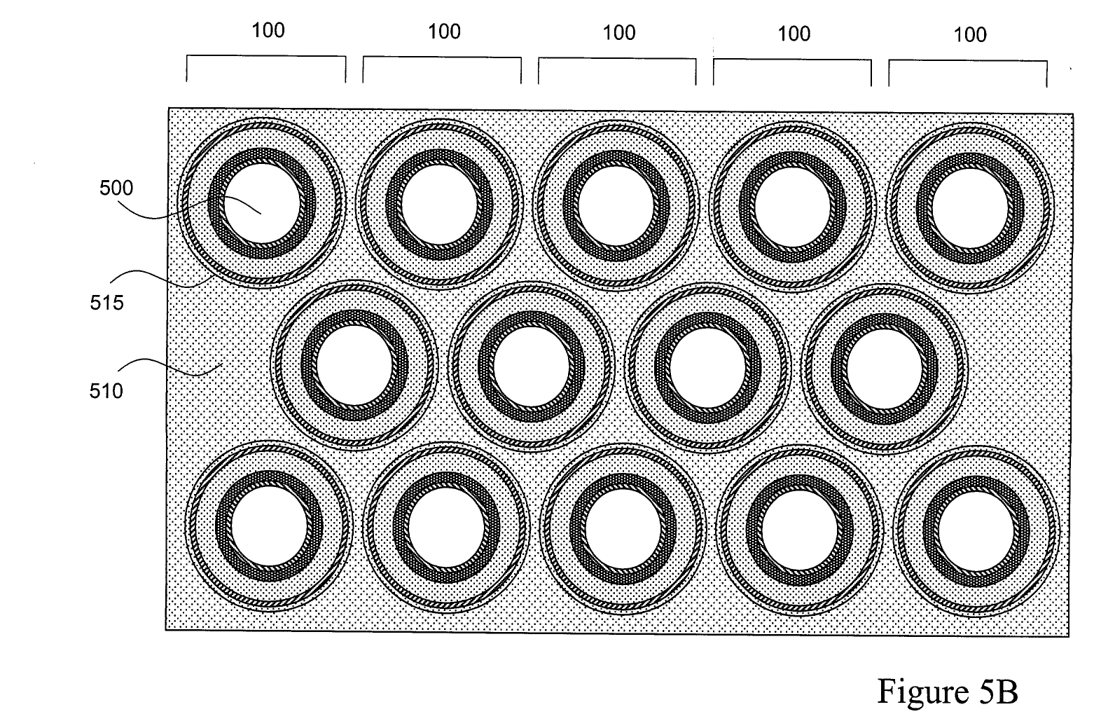

FIG. 5A is a side view and FIG. 5B is a corresponding cutaway diagram of a monotape of the present invention. In this example, the monotape has five layers of laden substrates rather than one layer of laden substrates. These figures depict an embodiment of the present invention employing insulating fiber 500 as a substrate and an insulating matrix as a configuring material 510. Also depicted are the laden substrates 100, which are packed in a dense configuration. In these depictions, lithium free electrochemical cells 515 are deposited on the insulating fibers 500. The laden substrates 100 (fiber and functional pattern) extend through the matrix of configuring material 510 to allow for electrical connections thereto, including connections to the ccc 520 or acc 530. The pattern of substrates 100 shown is described as an orange-crate configuration. An orange-crate configuration permits a high degree of density in a three-dimensional configuration, which may permit a high power to volume ratio in the multifunctional material. In other embodiments of the present invention, a lower density configuration may provide certain benefits, such as differing flexibility or weight. An orange-crate configuration may be created, for example, by bonding or laminating multiple monolayers, or by preform casting. An orange-crate configuration may be created, for example, by a casting process of stand alone laden substrates. An orange-crate configuration may also be created by impregnation, or infiltration of a layup of laden substrates 100 such as fibrous batteries. Bonding or laminating multiple monolayers into an orange-crate configuration may require that the original monolayers be preformed to permit staggered stacking as shown in FIGS. 5A and 5B. This particular structural form, however, is not required.

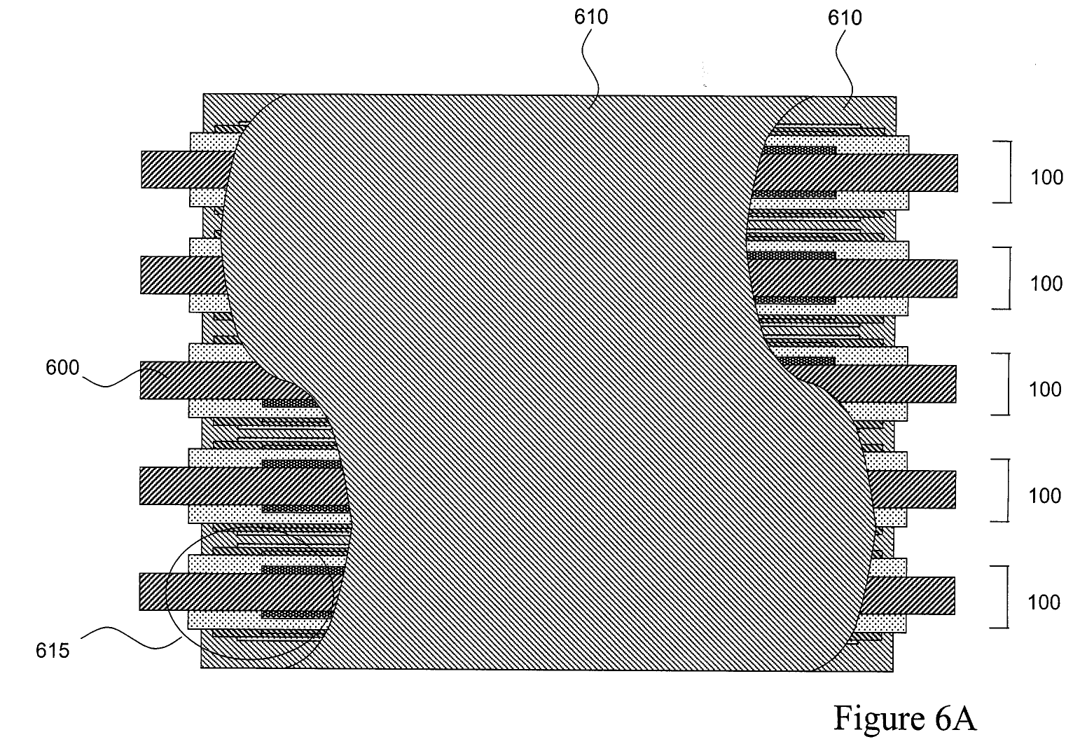

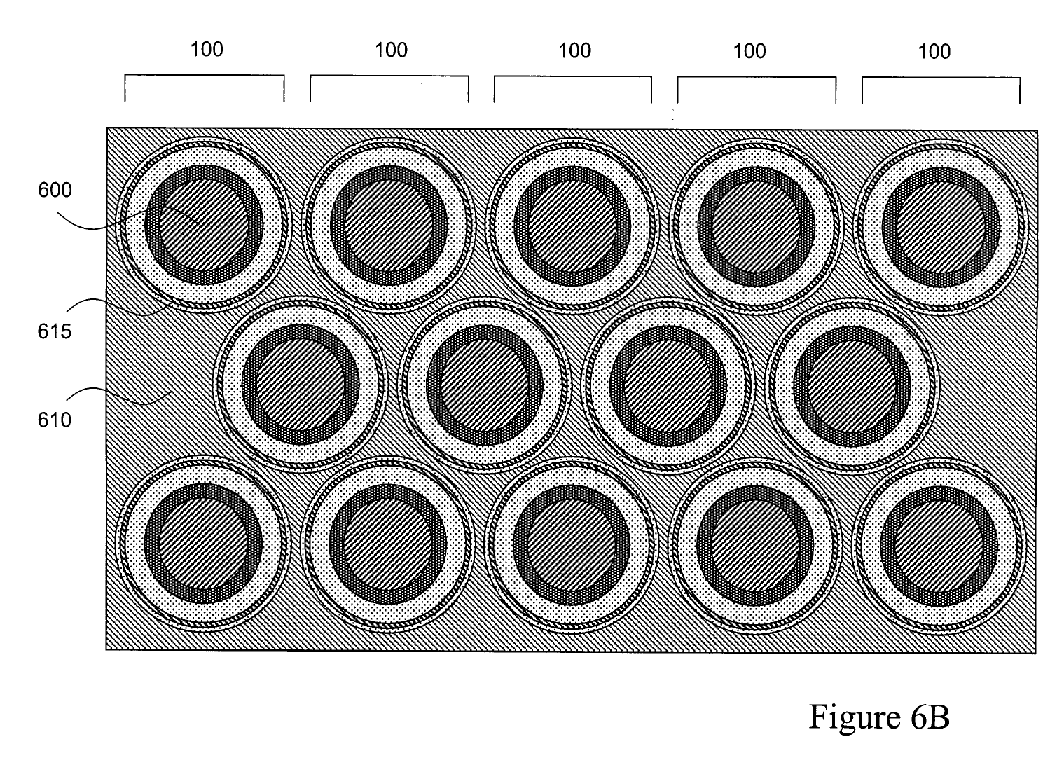

FIG. 6A is a side view and FIG. 6B is a corresponding cutaway diagram of a monotape of the present invention. These figures depict an embodiment of the present invention employing conducting fiber 600 as a substrate and a conducting matrix as a configuring material 610. Also depicted are the laden substrates 100, which are packed in a dense configuration. In these depictions, lithium-ion electrochemical cells 615 are deposited on the insulating fibers 600. The fibers 600 extend through the matrix material to allow for electrical connections to the fibers 600. Thus, the fibers 600 serve as acc's and the matrix configuring material 610 serves as a ccc. Laden substrates 100 are shown in an exemplary orange-crate configuration.

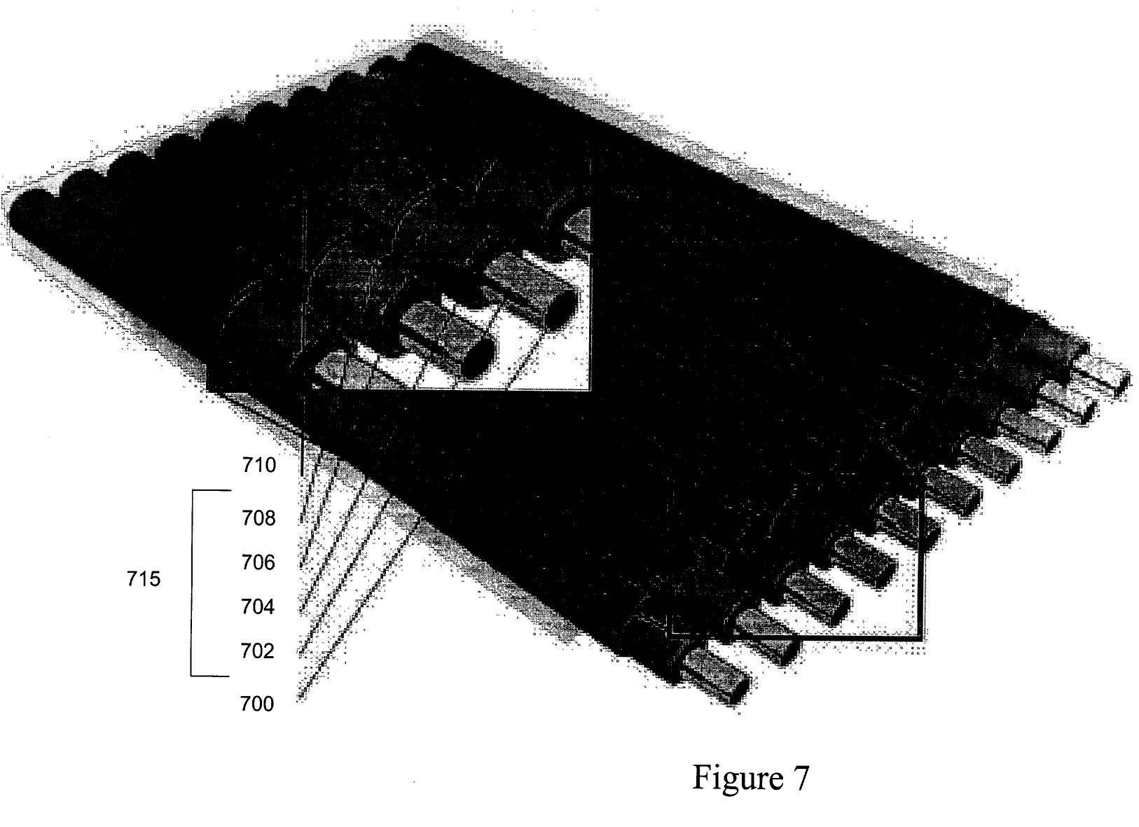

FIG. 7 is a perspective view and close up of an embodiment of a monolayer monotape of the present invention that is a single-ply PowerFiber™ reinforced composite. In this embodiment, the configuring material may have the function of being reinforced by the laden substrates, PowerFiber™ fibrous batteries. This figure illustrates a single layer monotape construction. The close up more clearly shows the matrix 710, anode layer 708, electrolyte layer 706, cathode layer 704, metalized contact 702, and underlying fiber substrate 700. The anode layer 708, electrolyte layer 706, cathode layer 704, and metalized contact 702 may be considered the electrochemical cell layers 715.

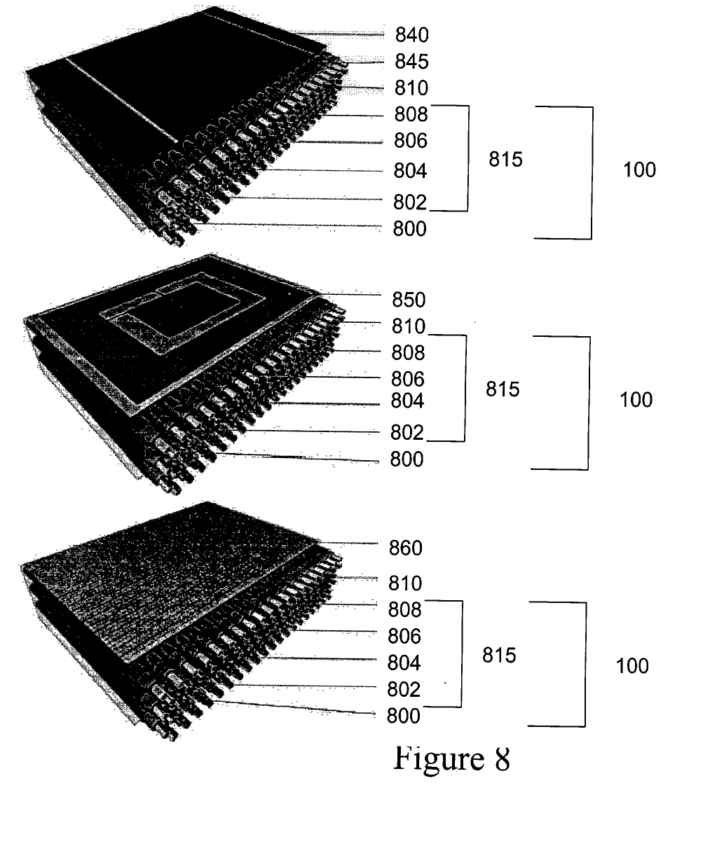

FIG. 8 is a depiction of three preferred embodiments of the present invention. Other possible configurations are also permitted. The first example from the top is a thin-film photovoltaics device with thin-film CIGS photovoltaics 840 and monolithic integration 845. The monolithic integration permits CIGS photovoltaic cells to be provided with a means of bypass in the event that the cell is sufficiently shaded. The monothically integrated protection may also prevent the underlying power composite from providing a destructive current to the CIGS photovoltaic cell. Monolithic integration additionally permits the use of bypass diodes that do not require soldered leads. This cell and its accompanying protection is placed on top of a monotape that includes laden substrates 100 in a matrix of configuring material 810. This example of a monotape includes a plurality of layers. The laden substrates 100 include, in this example, a fibrous substrate 800, a ccc 802, a cathode layer 804, an electrolyte layer 806, and an anode layer 808. The second example is a radio frequency identification (RFID) tag 850, which is placed on top of a monotape that includes laden substrates 100 in a matrix of configuring material 810. The laden substrates 100 include, in this example, a fibrous substrate 800, a ccc 802, a cathode layer 804, an electrolyte layer 806, and an anode layer 808. The third and bottom-most example is a direct conversion light antenna 860. A direct conversion light antenna converts electromagnetic energy in the visible or even radio frequency spectrum directly into electricity without an intervening chemical or biological process. This direct conversion light antenna is placed on top of a monotape that includes laden substrates 100 in a matrix of configuring material 810. The laden substrates 100 include, in this example, a fibrous substrate 800, a ccc 802, a cathode layer 804, an electrolyte layer 806, and an anode layer 808. The ccc 802, cathode layer 804, electrolyte layer 806, and anode layer 808 may be considered the electrochemical cell layers 815.

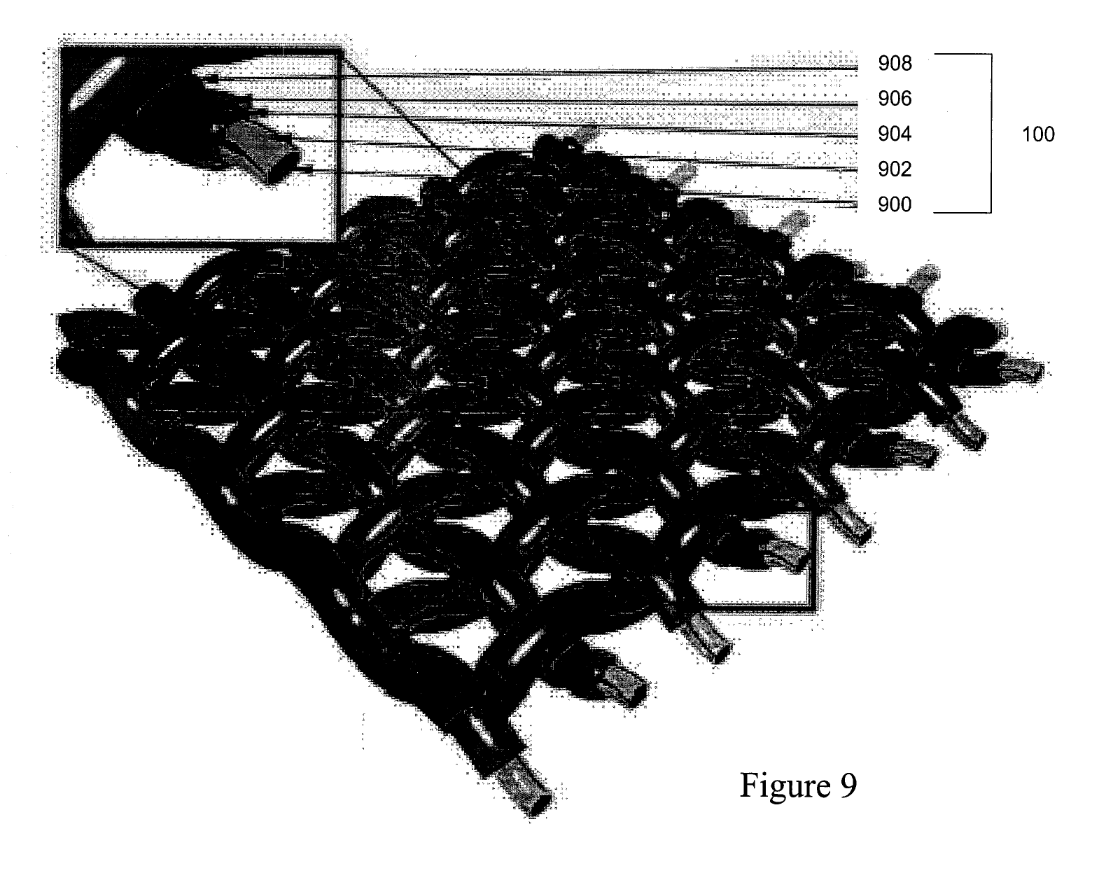

FIG. 9 is a perspective view and close-up view of PowerFiber™ weave for fabric and reinforced composites, which is a woven integration of laden substrates 100. This pattern is sometimes referred to as a fabric weave, and may be useful both in fabric and reinforced composites. Additionally, in this embodiment, the laden substrates are self-configuring, thus the laden substrate is the configuring material. Depicted in this example are anode layers 908, electrolyte layers 906, cathode layers 904, metalized contacts which may serve as ccc's 902, and fiber substrates 900. In this embodiment the laden substrates 100 serve as the configuring material. In some similar embodiments, the laden substrates 100 lying in one direction (warp or woof) or some fraction of those lying in one or more directions may be replaced with traditional textile fibers. The laden substrates may also be replaced by laden substrates of a different type (such as photovoltaic cell fibers). In such a situation, the laden substrates may be one of the configuring materials and the textile fibers may be another configuring material. Moreover, in other embodiments, a configuring material such as a matrix may be applied to, for example, encapsulate the interwoven substrates.

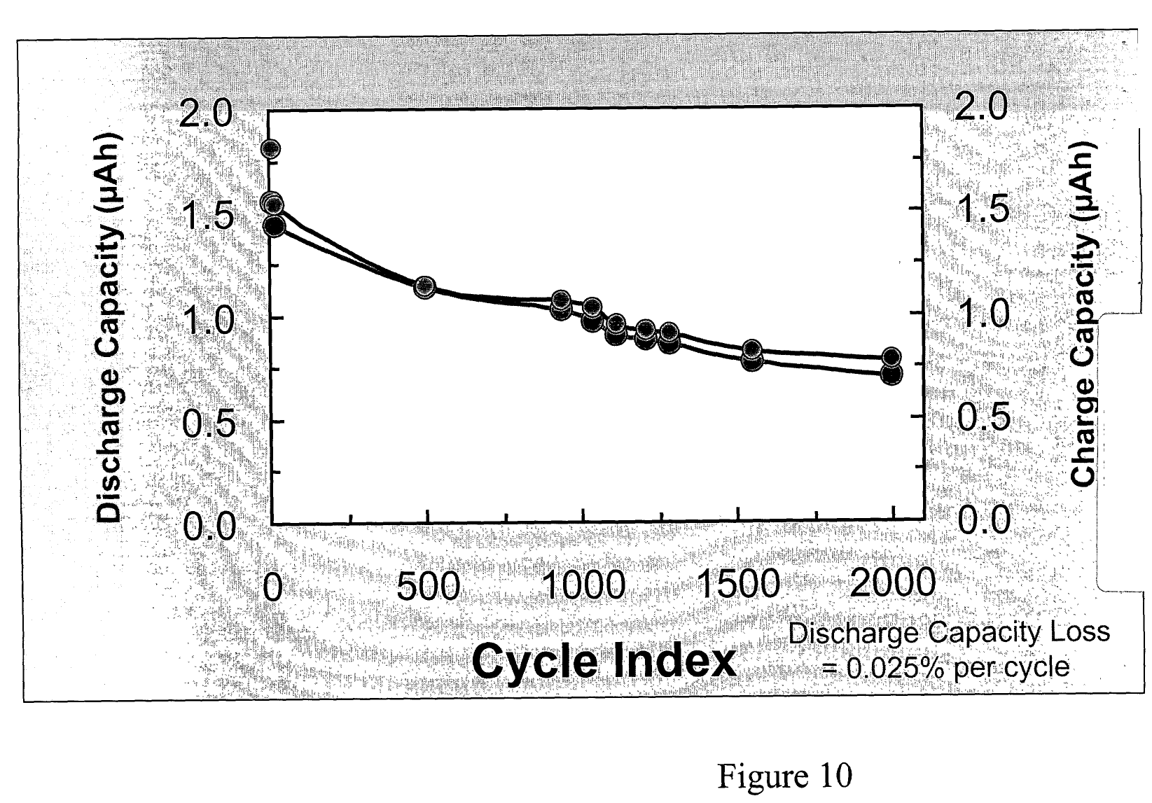

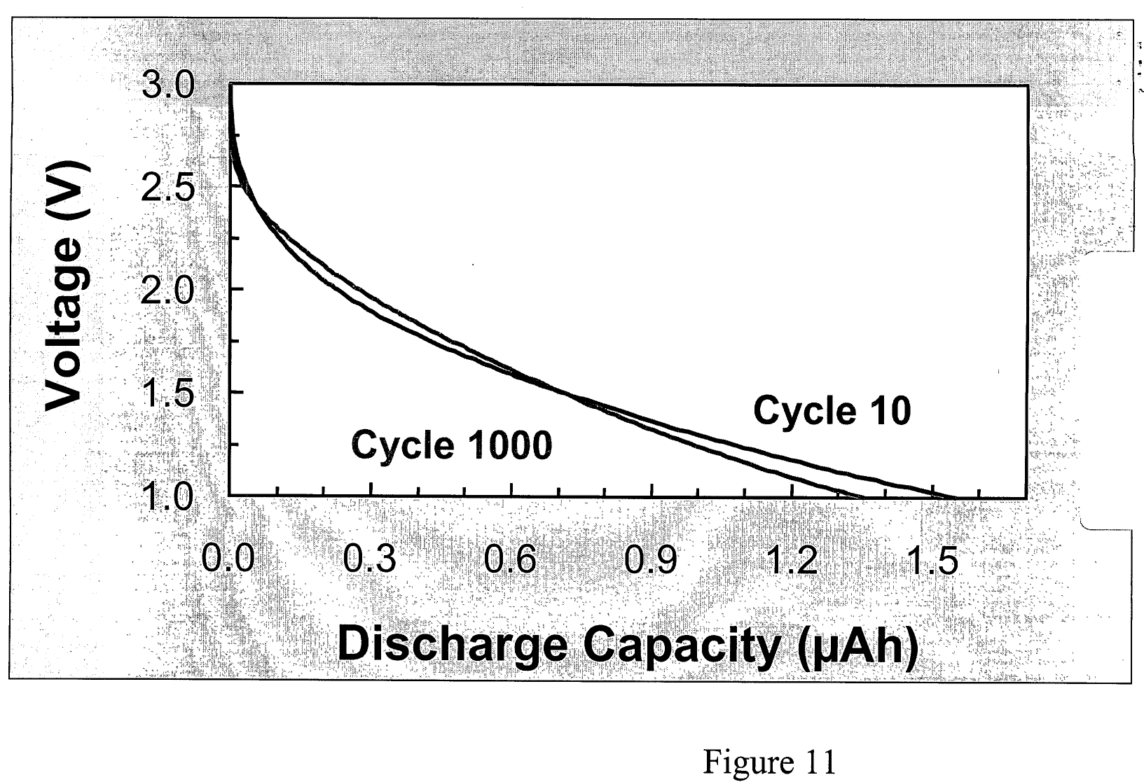

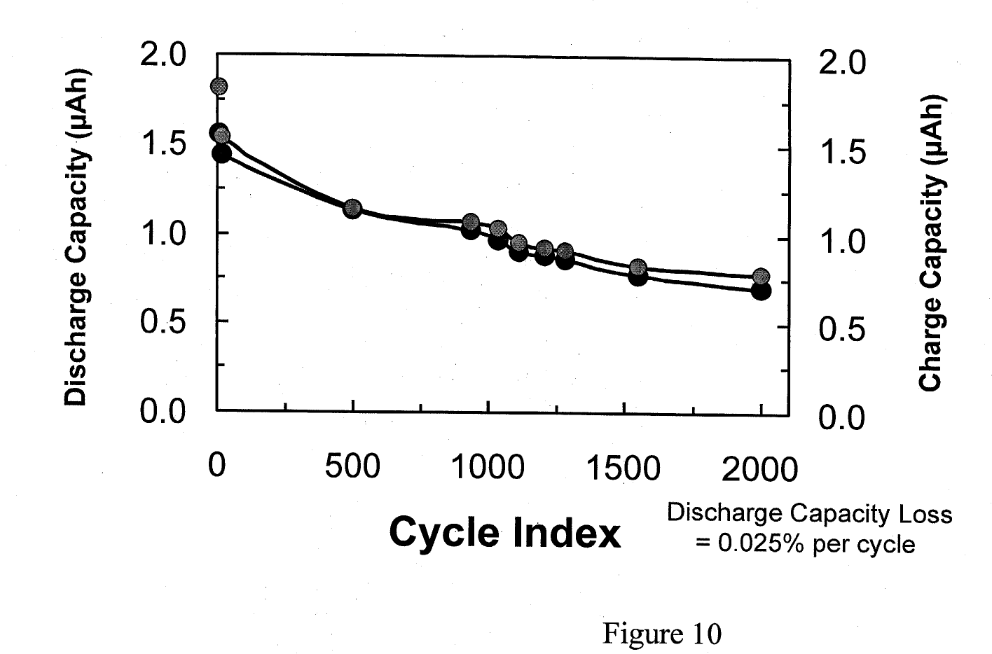

FIG. 10 is a graph of the-performance of an embodiment of the present invention in terms of discharge capacity in microampere-hours with respect to number of charge-discharge cycles. This performance data was generated by an example embodiment of the present invention that includes a composite of eight electrically parallel connected batteries on fibrous substrates. Each battery, in this example, has the battery configuration of a 150 μm diameter SiC fiber substrate, a 0.9 μm Cu inverted (buried) Li-free anode current collector layer, a 0.7 μm Lipon electrolyte layer, a 0.05 μm SnNₓ-Lipon absorption interlayer, a 0.8 μm Lipon electrolyte layer, a 0.4 μm Li₂V₂O₅ cathode/0.4 μm Cu cathode current collector layer, and a 0.4 μm Lipon protective overlayer. The cathode layer, in this example, extends about 5 cm. The total cross-sectional area for each battery, in this example, is approximately 0.24 cm². This figure demonstrates that if an embodiment of the present invention survives cycling for more than about 10 cycles without breaking or leaking it is very unlikely to develop a leak later, i.e., this embodiment of the present invention provides very good cycle stability. The plot shows this exceptionally high cycle stability (small capacity loss per cycle) in addition to the remarkable achievement of reaching 2000 cycles.

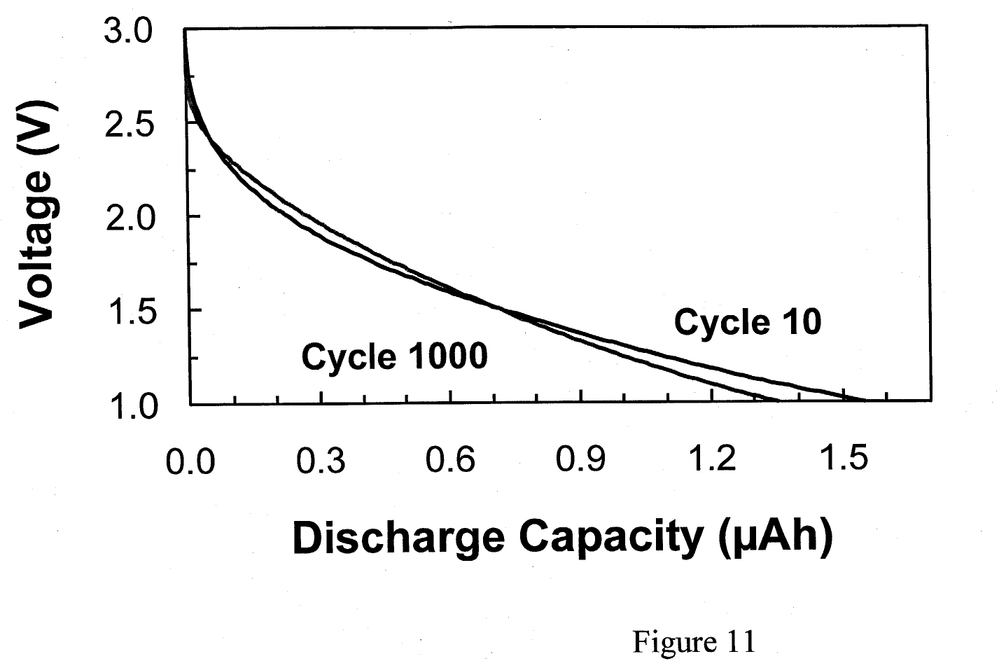

FIG. 11 is a graph of the performance of an embodiment of the present invention in terms of voltage with respect to discharge capacity measured in microampere-hours. This depicted performance data is based on an example embodiment of the present invention that includes a composite of eight electrically parallel connected batteries on fibrous substrates. In this example, each battery has the battery configuration of a 150 μm diameter SiC fiber substrate, a 0.9 μm Cu inverted (buried) Li-free anode current collector layer, a 0.7 μm Lipon electrolyte layer, a 0.05 μm SnNₓ-Lipon absorption interlayer, a 0.8 μm Lipon electrolyte layer, a 0.4 μm Li₂V₂O₅ cathode/0.4 μm Cu cathode current collector layer, and a 0.4 μm Lipon protective overlayer. The cathode layer, in this example, extends about 5 cm. The total cross-sectional area for each battery, in this example, is approximately 0.24 cm². This plot displays the pertinent discharge voltage profile between 3.0-1.0 V as a function of discharge capacity. The measurements were taken at cycles 10 and 1000 as shown. The almost identical shapes of these voltage profiles illustrates that this embodiment of the present invention configured in an inverted Li-free battery configuration and a Li₂V₂O₅ cathode undergoes only marginal changes during the course of 990 cycles.

Other embodiments of the invention will be apparent to those skilled in the art from consideration of the specification and the practice of the invention disclosed herein. It is intended that the specification and examples be considered as exemplary only, with a true scope and spirit of the invention being indicated by the following claims.

What is claimed is:

1. An apparatus for use as a multifunctional material comprising a laden substrate combined with a configuring material, wherein said laden substrate comprises a fibrous substrate upon which a multilayer functional thin-film pattern is deposited.

2. The apparatus of claim 1, wherein said fibrous substrate has a cross-section selected from the group consisting of: substantially circular; substantially ellipsoidal; substantially ribbon-like; and substantially strip-like.

3. The apparatus of claim 1, wherein said fibrous substrate comprises a material selected from a group consisting of: glass; ceramic; sapphire; polymer; optical fiber; metal; metal alloy; carbon; semiconductor; superconductor; shape memory alloy; and polished naturally occurring fibers.

4. The apparatus of claim 3, wherein said polished naturally occurring fibers comprise a material selected from a group consisting of: wool; cotton; hemp; and wood.

5. The apparatus of claim 1, wherein said fibrous substrate has a length of between approximately one-quarter inch and approximately three hundred meters.

6. The apparatus of claim 1, wherein said fibrous substrate comprises between about five and about ninety-five percent of the volume of said multifunctional material.

7. The apparatus of claim 1, wherein said multilayer functional thin-pattern comprises between about 0.1 percent and about 90 percent of the volume of said multifunctional material.

8. The apparatus of claim 1, wherein said multilayer functional thin-film pattern comprises a pattern selected from a group consisting of: a lithium battery configuration; a buried lithium battery configuration; a lithium-ion battery configuration; a buried lithium-ion battery configuration; a lithium-free battery configuration; a buried lithium-free battery configuration; a photovoltaic device configuration; and a multilayer electronic interconnect configuration.

9. The apparatus of claim 1, wherein said configuring material comprises said laden substrate.

10. The apparatus of claim 1, wherein said configuring material comprises a material selected from a group consisting of: an insulating polymer; insulating polymer base; conducting polymer; conducting polymer base; resin; ceramic; glass; metal; metal alloy; carbon; carbon compound; bismaleimide-SiO₂; silicones; parylene; parylene multilayered with inorganics; polyacrylate; polyacrylate multilayered with inorganics; rubber; thick vacuum deposited air-insensitive inorganics; thick vacuum deposited lithium phosphorous oxynitride; polymer; metal film; metal foil; metal alloy film; metal alloy foil; insulating adhesive; conductive adhesive; dielectric adhesive; and dielectric.

11. The apparatus of said claim 1, wherein said configuring material provides an electrode terminal comprising a terminal selected from the group of an anode and a cathode.

12. The apparatus of claim 1, wherein said configuring material comprises a material selected for a specified function.

13. The apparatus of claim 12, wherein said specified function comprises a function selected from a group consisting of the following: to reinforce said laden substrate, to be reinforced by said laden substrate, to thermally insulate said laden substrate, to electrically insulate said laden substrate, to provide heat transfer with said laden substrate, to shade said laden substrate, to provide static shape to said laden substrate, to provide dynamic shape to said laden substrate, to encapsulate said laden substrate, to provide lubrication to said laden substrate, to provide dimensions to said laden substrate, to provide mechanical shock absorption to said laden substrate, to provide electrical shock absorption to said laden substrate, to provide electrical conductivity to said laden substrate, to provide electrical connection to said laden substrate, to provide color to said laden substrate, to prevent exposure of said laden substrate, to enhance exposure of said laden substrate, to reinforce said multifunctional material, to thermally insulate said multifunctional material, to electrically insulate said multifunctional material, to provide heat transfer with said multifunctional material, to shade said multifunctional material, to provide static shape to said multifunctional material, to provide dynamic shape to said multifunctional material, to encapsulate said multifunctional material, to provide lubrication to said multifunctional material, to provide dimensions to said multifunctional material, to provide mechanical shock absorption to said multifunctional material, to provide electrical shock absorption to said multifunctional material, to provide electrical conductivity to said multifunctional material, to provide electrical connection to said multifunctional material, to provide color to said multifunctional material, to prevent exposure of said multifunctional material, and to enhance exposure of said multifunctional material.

14. The apparatus of claim 13, wherein said function to encapsulate laden substrate comprises an encapsulant selected from the group consisting of a single layer encapsulant and a multilayer plastic coating.

15. The apparatus of claim 14, wherein said single layer encapsulant comprises a material selected from the group consisting of: silicon oxide based glass; teflon; parylene; low-density polyethylene; and polyacrylate.

16. The apparatus of claim 14, wherein said multilayer plastic coating comprises at least two plastic/metal layers wherein each plastic/metal layer comprises a layer of a metal and a layer of a plastic applied to said layer of metal.

17. The apparatus of claim 16, wherein said plastic comprises parylene.

18. The apparatus of claim 16, wherein said metal comprises a material selected from the group consisting of: Ti; Al; Cr; Al₂O₃; and Cr₂O₃.

19. The apparatus of claim 13, wherein said function to reinforce said multifunctional material is accomplished by means of a reinforcement member selected from the group consisting of: a cylindrical fiber; a monofilament; a wire; and a rod.

20. The apparatus of claim 19, wherein said reinforcement member has a diameter of between about one micron and about one-quarter inch.

21. The apparatus of claim 19, wherein said reinforcement member has a diameter of between about ten microns and about 0.025 inches.

22. The apparatus of claim 13, wherein said function to reinforce said multifunctional material is accomplished by means of a substantially rectangular reinforcement member comprising a material selected from the group consisting of: carbon; carbon compound; conducting polymer; insulating polymer; glass; resin; ceramic; metal; metal alloy; and shape memory alloy.

23. The apparatus of claim 22, wherein said rectangular reinforcement member has a length of between about one micron and about five inches.

24. The apparatus of claim 22, wherein said rectangular reinforcement member has a width of between about one micron and about five inches.

25. The apparatus of claim 22, wherein said rectangular reinforcement member has a length of between about ten microns and about one-quarter inch.

26. The apparatus of claim 22, wherein said rectangular reinforcement member has a width of between about ten microns and about one-quarter inch.

27. The apparatus of claim 13, wherein said function to reinforce said multifunctional material is accomplished by means of said laden substrate.

28. The apparatus of claim 1, further comprising a portion of said configuring material adapted to provide exposure to a portion of said laden substrate.

29. The apparatus of claim 28, further comprising an exposed electrical terminal.

30. The apparatus of claim 1, wherein said multifunctional material comprises a single laden substrate together with an encapsulating configuring material.

31. A method for manufacturing multifunctional materials comprising the steps of: providing a fibrous substrate; creating a laden substrate by depositing a multi-functional thin film pattern on said fibrous substrate; and combining said laden substrate with a configuring material.

32. The method of claim 31, wherein said fibrous substrate is selected to have a cross-section selected from the group consisting of: substantially circular; substantially ellipsoidal; substantially ribbon-like; and substantially strip-like.

33. The method of claim 31, wherein said fibrous substrate comprises a material selected from a group consisting of: glass; ceramic; sapphire; polymer; optical fiber; metal; metal alloy; carbon; semiconductor; superconductor; shape memory alloy; and polished naturally occurring fibers.

34. The method of claim 33, wherein said polished naturally occurring fibers comprise a material selected from a group consisting of: wool; cotton; hemp; and wood.

35. The method of claim 31, further comprising providing said fibrous substrate having a length of between approximately one-quarter inch and approximately three hundred meters.

36. The method of claim 31, further comprising said fibrous substrate comprising between about five and about ninety-five percent of the volume of said multifunctional material.

37. The method of claim 31, wherein said multilayer functional thin-pattern is selected to comprise between about 0.1 percent and about 90 percent of the volume of said multifunctional material.

38. The method of claim 31, wherein said multilayer functional thin-film pattern comprises a pattern selected from a group consisting of: a lithium battery configuration; a buried lithium battery configuration; a lithium-ion battery configuration; a buried lithium-ion battery configuration; a lithium-free battery configuration; a buried lithium-free battery configuration; a photovoltaic device configuration; and a multilayer electronic interconnect configuration.

39. The method of claim 31, wherein said configuring material comprises said laden substrate.

40. The method of claim 31, wherein said configuring material comprises a material selected from a group consisting of: insulating polymer; insulating polymer base; conducting polymer; conducting polymer base; resin; ceramic; glass; metal; metal alloy; carbon; carbon compound; bismaleimide-SiO₂; silicones; parylene; parylene multilayered with inorganics; polyacrylate; polyacrylate multilayered with inorganics; rubber; thick vacuum deposited air-insensitive inorganics; thick vacuum deposited lithium phosphorous oxynitride; polymer; metal film; metal foil; metal alloy film; metal alloy foil; insulating adhesive; conductive adhesive; dielectric adhesive; and dielectric.

41. The method of said claim 31, wherein said configuring material provides an electrode terminal comprising a terminal selected from the group of an anode and a cathode.

42. The method of claim 31, wherein said configuring material comprises a material selected for a specified function.

43. The method of claim 42, wherein said specified function comprises a function selected from a group consisting of the following: to reinforce said laden substrate; to be reinforced by said laden substrate; to thermally insulate said laden substrate; to electrically insulate said laden substrate; to provide heat transfer with said laden substrate; to shade said laden substrate; to provide static shape to said laden substrate; to provide dynamic shape to said laden substrate; to encapsulate said laden substrate; to provide lubrication to said laden substrate; to provide dimensions to said laden substrate; to provide mechanical shock absorption to said laden substrate; to provide electrical shock absorption to said laden substrate; to provide electrical conductivity to said laden substrate; to provide electrical connection to said laden substrate; to provide color to said laden substrate; to prevent exposure of said laden substrate; to enhance exposure of said laden substrate; to reinforce said multifunctional material; to thermally insulate said multifunctional material; to electrically insulate said multifunctional material; to provide heat transfer with said multifunctional material; to shade said multifunctional material; to provide static shape to said multifunctional material; to provide dynamic shape to said multifunctional material; to encapsulate said multifunctional material; to provide lubrication to said multifunctional material; to provide dimensions to said multifunctional material; to provide mechanical shock absorption to said multifunctional material; to provide electrical shock absorption to said multifunctional material; to provide electrical conductivity to said multifunctional material; to provide electrical connection to said multifunctional material; to provide color to said multifunctional material; to prevent exposure of said multifunctional material; and to enhance exposure of said multifunctional material.

44. The method of claim 43, wherein said function to encapsulate laden substrate comprises an encapsulant selected from the group consisting of a single layer encapsulant, and a multilayer plastic coating.

45. The method of claim 44, wherein said single layer encapsulant comprises a material selected from the group consisting of: silicon oxide based glass; teflon; parylene; low-density polyethylene; and polyacrylate.

46. The method of claim 44, wherein said multilayer plastic coating comprises at least two plastic/metal layers wherein each plastic/metal layer comprises a layer of a metal, and a layer of a plastic applied to said layer of metal.

47. The method of claim 46, wherein said plastic comprises parylene.

48. The method of claim 46, wherein said metal comprises a material selected from the group consisting of: Ti; Al; Cr; Al₂O₃; and Cr₂O₃.

49. The method of claim 43, wherein said function to reinforce said multifunctional material is accomplished by means of a reinforcement member selected from the group consisting of: a cylindrical fiber; a monofilament; a wire; and a rod.

50. The method of claim 49, wherein said reinforcement member has a diameter of between about one micron and about one-quarter inch.

51. The method of claim 49, wherein said reinforcement member has a diameter of between about ten microns and about 0.025 inches.

52. The method of claim 43, wherein said function to reinforce said multifunctional material is accomplished by means of a substantially rectangular reinforcement member comprising a material selected from the group consisting of: carbon; carbon compound; conducting polymer; insulating polymer; glass; resin; ceramic; metal; metal alloy; and shape memory alloy.

53. The method of claim 52, wherein said rectangular reinforcement member has a length of between about one micron and about five inches.

54. The method of claim 52, wherein said rectangular reinforcement member has a width of between about one micron and about five inches.

55. The method of claim 52, wherein said rectangular reinforcement member has a length of between about ten microns and about one-quarter inch.

56. The method of claim 52, wherein said rectangular reinforcement member has a width of between about ten microns and about one-quarter inch.

57. The method of claim 43, wherein said function to reinforce said multifunctional material is accomplished by means of said laden substrate.

58. The method of claim 31, further comprising the step of removing a portion of said configuring material removed.

59. The method of claim 58, wherein said step of removing a portion of said configuring material comprises exposing an electrical terminal.

60. The method of claim 58, wherein said step of removing a portion of said configuring material comprises a technique selected from a group consisting of: chemically removing; etching; laser scribing; laser ablating; photolithography; thin-film patterning; and mechanically removing.

61. The method of claim 60, wherein said technique of photolithography further comprises chemical removal of photoresist.

62. The method of claim 60, wherein said technique of photolithography further comprises e-beam removal of photoresist.

63. The method of claim 31, wherein said step of combining said laden substrate with a configuring material comprises configuring said laden substrate.

64. The method of claim 63, wherein said step of configuring said laden substrate comprises one ore more techniques selected from the group consisting of the following: positioning said laden substrate parallel to one or more laden substrates; providing said laden substrate with a desired curvature; intertwining said laden substrate with one or more other laden substrates; intertwining said laden substrate with itself; and placing one or more laden substrates into a mold.

65. The method of claim 31, wherein said step of combining said laden substrate with a configuring material comprises one or more techniques selected from a group consisting of: casting; compressing; extruding; molding; impregnating; winding; linear/alternating-transverse pre-forming; coil pre-forming; roll-compacting; laminating; bonding; braiding; and weaving.

66. The method of claim 31, wherein said step of providing a laden substrate comprises providing a single substrate, and said step of combining said laden substrate with a configuring material comprises encapsulating said single substrate with a configuring material.

67. An apparatus for use as a fabric comprising a plurality of laden substrates interwoven with a plurality of conventional fabric fibers, wherein each of said laden substrates comprises a fibrous substrate upon which a multilayer functional thin-film pattern has been deposited.

68. An apparatus for use as a fabric comprising a plurality of laden substrates interwoven with each other, wherein each of said laden substrates comprises a fibrous substrate upon which a multilayer functional thin-film pattern has been deposited.

69. An apparatus for use as a DC power supply comprising a plurality of laden substrates combined with an encapsulating matrix, wherein each of said laden substrates comprises a fibrous substrates upon which a multilayer functional thin-film pattern has been deposited.

70. An apparatus for use as a power conversion system comprising a current producing layer, and connected to said current producing layer a multifunctional material comprising a plurality of laden substrates, combined with a configuring material, wherein each of said laden substrates comprises a fibrous substrate upon which has been deposited a multilayer functional thin-film pattern.

71. The apparatus of claim 70, wherein said current producing layer comprises a device selected from the group consisting of: an RF identification tag; a thin-film photovoltaic device; a thin-film CIGS photovoltaic device; and a direct conversion light antenna.

72. The apparatus of claim 70, wherein said configuring material comprises a matrix.

73. The apparatus of claim 70, wherein said deposited multilayer functional thin-film pattern comprises a pattern selected from a group consisting of: a lithium battery configuration; a buried lithium battery configuration; a lithium-ion battery configuration; a buried lithium-ion battery configuration; a lithium-free battery configuration; and a buried lithium-free battery configuration.
